(19) United States
(12) Patent Application Publication
(10) Pub. No.: US 2002/0016758 A1
(43) Pub. Date: Feb. 7, 2002

(54) Method and apparatus for offering, pricing, and selling securities over a network

(76) Inventor: Calvin B. Grigsby, Blackhawk, CA (US)

Correspondence Address: Alan S. Hodes, Morrison & Foerster LLP, 755 Page Mill Road, Palo Alto, CA, 94304-1018, US

(21) Appl. No.: 09/896,831

(22) Filed: Jun. 28, 2001

Related U.S. Application Data
(60) Provisional application No. 60/214,820, filed on Jun. 28, 2000.

(51) Int. Cl. G06F 17/60

(52) U.S. Cl. 705/36

(57) ABSTRACT

The present invention relates to a system and method of offering, automatically pricing, preparing for sale, selling, and managing securities, such as municipal bonds, over a network, such as the Internet. The present invention also relates to a system and method for an on-line, one-stop and one-source platform for municipal borrowing, production of associated bond legal documents and offering materials, and satisfaction of continuing disclosure requirements.

### CROSS-REFERENCE TO RELATED APPLICATIONS

This application claims the benefit of U.S. Provisional Application No. 60/214,820 filed Jun. 28, 2000.

### TECHNICAL FIELD

The present invention relates to a system and method of managing securities, such as municipal bonds, and transactions associated with the securities over a network.

### BACKGROUND ART

There is currently in excess of $1.5 trillion of municipal debt outstanding, compared to the corporate bond market of $3.0 trillion and the $2.2 trillion mortgage-backed securities market. There are approximately 10,000 new tax-exempt issues sold each year, and roughly 70 percent of these issues are less than 10 million in size. Each municipal issuer under the present system of municipal bond underwriting utilizes a financial advisor, underwriter, and bond counsel, as well as staff financial officers, to issue bonds, following a public approval process that includes an ordinance approved by a governing body, and quite often a vote of an electorate. In some municipalities, a vote is required where property taxes or sales taxes rather than “user fee” revenues are pledged to repay the issue. At the end of 1999, individuals and finds managing money for individuals money held the largest percentage of the total outstanding supply of municipal bonds.

Municipal debt is entirely domestic because yields are lower than comparable taxable debt. Municipal yields are lower because individuals, corporations, insurance companies, and financial institutions, can receive interest on the municipal bonds free of federal taxation on income, to various extents.

Investors accept lower yields because the interest paid to them on most municipal bonds is exempt from federal income taxes and, in most cases, from state and local income taxes in the state of issuance.

The municipal bond market is not as liquid as the U.S. Treasury bond and other domestic bond markets. Retail and institutional investors typically purchase municipal bonds, or municipals, with the intent to hold them until maturity. The average daily trading volume for municipals is small when compared to the mortgage-related securities and U.S. Treasury markets.

A number of factors limit the liquidity of the municipal bond market. First, the municipal market does not trade off of the U.S. Treasury market. Consequently, neither dealers nor investors can effectively hedge positions in municipal securities with treasuries or treasury futures. The tax-exempt nature of interest complicates dealer ability to make a two-sided market. In effect, short sales of securities that a dealer does not already own may be construed as the creation of taxable income.

Second, the vast number of discrete securities outstanding in the market tends to fragment the market, which makes short sales extremely risky. Third, there is a large number of different municipal securities, and each bond varies by the structure of the issue and by the issuers. Factors that affect the pricing of municipal securities are maturity, redemption features, interest rate structure, ratings, credit enhancement security, industry and purpose, tax status, size of trade, name recognition, size of debt program, credit quality, location, and disclosure policies.

Presently, municipal bonds are bought, sold, and priced on the basis of credit quality, maturity, liquidity, and yield. Yield is the most important element for an investor in evaluating the merits of an investment transaction and in comparing costs of alternatives because it tells the investor how hard the investment is working. Bond dealers compete with each other for customers on the basis of yield as well as service. Each bond dealer prices the bonds it offers at a yield that takes into consideration a number of factors: interest rate levels, supply and demand for the bond, creditworthiness of the issuer, similarities to other bonds, maturity, call provisions, size of the order, and reliability of the dealer. Dealers also compare their pricing with two established daily generic indexes, “Municipal Market Data” published by Thompson Municipal Market Monitor and “Municipal Bond Yields” published at the end of each trading day by The Bond Market Association and Bloomberg L.P. These indexes are derived at the end of a trading day from a review of bonds trading on that day and other market data.

Transaction costs on municipal bonds are generally between 0.5 percent and 2.5 percent, depending on the size of the order, the maturity of the bonds, and the services provided by the broker. The amount of mark-up or mark-down must be fair and equitable, taking into consideration all relevant factors, such as market price, expense, and the dealer's right to earn a profit on the transaction. However, since the investor focuses on yield, versus taxable yields, mark-ups vary widely on the same bond from dealer to dealer.

One way for the investor to determine whether he or she is paying an appropriate (loosely, “fair”) price, is to compare the suggested bonds on the basis of yield, creditworthiness, and responsiveness to other investment parameters. Select newspapers publish daily a list of actively traded bonds that support the municipal futures contract. The generic yield scales referred to above are the primary tools by which individual investors can compare yields.

If the buyer wants to track the approximate market value of a bond, the buyer can keep the bond in a brokerage account, which provides its market value on a monthly statement. If the brokerage firm that sold the bonds does not hold securities for its customers, the customer can periodically call the customer's broker and ask for an estimate of the current market value. There is no current system available for an investor to obtain a real-time value of a municipal bond portfolio.

The borrower, or issuer of bonds, establishes a sales price in two different ways, depending on whether he or she elects to competitively bid or negotiate the issue. If the issue is competitively bid, the issuer financial staff and/or financial advisor determines the amount to be borrowed and the repayment schedule, hires bond counsel to prepare documents and resolutions, and qualifies the issue for bond insurance, if available. A date is selected for bids to be received, and investment banks or syndicates of investment banks submit bids either in person at the clerk's office or using on-line bidding services.

The bidder with the lowest total interest cost, i.e., highest purchase price, is allowed to buy the bonds. Bids received are typically within four or five basis points of each other. For example, in a recent Oakland Unified School District General Obligation $75,000,000 bond sale, the four competitive bids were 5.535%, 5.5574%, 5.5588%, and 5.5769%, a spread of 4.19 basis points between four bids. Therefore, the total difference in the bids was roughly $18,300 per year, or a present value of $230,000 over the life of the issue. The underwriter's discount on a $75 million issue averages $5 per bond, or $375,000. Rough additional costs are: bond counsel—$150,000, financial advisor—$60,000, printing—$20,000, and mailing and miscellaneous—$10,000, summing to approximately $240,000.

If the borrower negotiates the issue with a selected underwriter, the process works somewhat differently. The borrower issues a request for qualifications, to which 10 or more underwriters respond. Each proposal is reviewed by the staff and financial advisor and ranked. The three or four “shortlisted” proposers are often given the right to make oral presentations, and a finalist is chosen as lead underwriter, with remaining “shortlisted” firms asked to join the underwriting syndicate as co-managers. On the day of pricing, interested buyers subscribe to the bonds. If the issue is “oversubscribed,” the price is raised. If the issue is “undersubscribed,” the interest rate is increased, i.e., the price of bonds is reduced, in order to bring in more buyers until the financial advisor and the underwriting syndicate reach an agreed upon final price.

There are a number of studies relating to whether negotiated or competitive bids bring the best price, or lower interest rate, for the issuer. Issues of general obligation (property tax backed) bonds and smaller issues under $100 million tend to be competitively bid. Revenue backed, as opposed to property tax backed, bonds and larger bond issues over $100 million tend to be negotiated. Regardless of whether an issuer borrows through a competitive or negotiated process, the prices on a given day for bonds from the same region having similar legal structures and similar credit ratings typically do not vary by more than five basis points when actual rates are compared to that day's generic index.

### SUMMARY OF THE INVENTION

The system and/or method in accordance with embodiments of the present invention relates to an on-line municipal bond underwriting method and system having subscribers. In an aspect of the invention, subscribers may be issuers and/or purchasers. An issuer may be a state government, a local government, an individual or other entity wishing to raise capital in a municipal bond market. A subscriber may be an individual or an individual's surrogate or other entity seeking to purchase municipal debt obligations. By eliminating costly intermediaries presently involved in arranging municipal loans, the system and/or method in accordance with embodiments of the present invention enables issuers to sell municipal obligations based on a munindex pricing engine of the system and/or method in accordance with embodiments of the present invention.

In a further aspect of the invention, the munindex pricing engine computes bond prices that are guaranteed to be equivalent to and/or competitive with prevailing market rates for comparable securities. In a further aspect of the invention, a web site associated with the system and/or method in accordance with embodiments of the present invention enables an issuer to sell municipal bonds at market prices based on calculations of the munindex pricing engine plus a standard transaction fee. In a further aspect of the invention, a purchaser may list his or her portfolio of municipal bonds on a secure database. In a further aspect of the invention, a purchaser may receive a real time portfolio evaluation at any time. The portfolio evaluation may be free of charge. In a further aspect of the invention, the web site may evaluate stock prices of closed end municipal funds based on the munindex pricing engine and alert potential purchasers or investors to funds that may represent buying or selling opportunities.

In the prior art, issuers rely on financial advisors who evaluate market data subjectively and advise as to “appropriate” yield on securities, such as but not limited to municipal bonds, in confirmation with a review of bids actually received in a competitive bidding process, or a reviewed bid in a negotiation process. Also in the prior art, issuers rely on bond counsel to tell them what loan documents are approved and to write an opinion on tax exemptions or exceptions for the securities, such as but not limited to municipal bonds.

In an aspect of the invention, an automated munindex pricing engine of the system and/or method in accordance with embodiments of the present invention may determine, for example at the end of each trading day, yields for bonds, based on market indices, current trades, special characteristics of the bonds to be sold, and other factors, therefore eliminating the need for financial advisors and traditional underwriters. In a further aspect of the invention, a web site associated with the system and/or method in accordance with embodiments of the present invention provides combinations of information for future and past securities offerings, such as but not limited to bond offerings, historical data, related news articles, free portfolio evaluations, and other services.

In a further aspect of the invention, the system and/or method in accordance with embodiments of the present invention offers and sells securities, such as but not limited to municipal bonds, without traditional securities sale requirements. In a further aspect of the invention, the system and/or method in accordance with embodiments of the present invention allows for a paperless system of disclosure, use of standard documentation on-line, continuing disclosure on-line, and elimination of the need for a financial printer.

In a further aspect of the invention, the system and/or method in accordance with embodiments of the present invention may present an on-line secondary market for a securities sale, such as a bond sale, using yields calculated by a munindex pricing engine. In a further aspect of the invention, the secondary market sale may occur after an initial offering or issuance sale. In a further aspect of the invention, the secondary market sale may involve a sale of bonds from entities that purchased the bonds in an earlier initial offering or issuance sale.

In a further aspect of the invention, the system and/or method in accordance with embodiments of the present invention sells securities, such as but not limited to municipal bonds, without a tax opinion from a bond counsel. In a further aspect of the invention, the system and/or method in accordance with embodiments of the present invention may be associated with a legal validity opinion rendered by an issuer of the securities. In a further aspect of the invention, the system and/or method in accordance with embodiments of the present invention may use in-house counsel and eliminate the need for bond counsel.

### BRIEF DESCRIPTION OF THE DRAWINGS

FIG. 1 shows a screen shot for an exemplary embodiment of a home page for a web site associated with the system and/or method in accordance with embodiments of the present invention.

FIG. 2 shows a screen shot for an exemplary embodiment of a web page displaying an application for money screen associated with the system and/or method in accordance with embodiments of the present invention.

FIG. 3 shows a screen shot for an exemplary embodiment of a web page displaying an issuer application form screen associated with the system and/or method in accordance with embodiments of the present invention.

FIG. 4 shows a screen shot for an exemplary embodiment of a web page displaying an issuer login screen associated with the system and/or method in accordance with embodiments of the present invention.

FIG. 5 shows a screen shot for an exemplary embodiment of a web page displaying an issuer screen associated with the system and/or method in accordance with embodiments of the present invention.

FIG. 6 shows a screen shot for an exemplary embodiment of a web page displaying a pricing date selection screen associated with the system and/or method in accordance with embodiments of the present invention.

FIG. 7 shows a screen shot for an exemplary embodiment of a web page displaying a pricing results screen associated with the system and/or method in accordance with embodiments of the present invention.

FIG. 8 shows a screen shot for an exemplary embodiment of a web page displaying an investor screen associated with the system and/or method in accordance with embodiments of the present invention.

FIG. 9 shows a screen shot for an exemplary embodiment of a web page displaying an investor login screen associated with the system and/or method in accordance with embodiments of the present invention.

FIG. 10 shows a screen shot for an exemplary embodiment of a web page displaying an individual investor application screen associated with the system and/or method in accordance with embodiments of the present invention.

FIG. 11 shows a screen shot for an exemplary embodiment of a web page displaying an institutional investor application screen associated with the system and/or method in accordance with embodiments of the present invention.

FIG. 12 shows a screen shot for an exemplary embodiment of a web page displaying a registration confirmation screen associated with the system and/or method in accordance with embodiments of the present invention.

FIG. 13 shows a screen shot for an exemplary embodiment of a web page displaying an investor login screen associated with the system and/or method in accordance with embodiments of the present invention.

FIG. 14 shows a screen shot for an exemplary embodiment of a web page displaying an investor selection screen associated with the system and/or method in accordance with embodiments of the present invention.

FIG. 15 shows a screen shot for an exemplary embodiment of a web page displaying a municipal bond marketplace screen associated with the system and/or method in accordance with embodiments of the present invention.

FIG. 16 shows a screen shot for an exemplary embodiment of a web page displaying a bond range selection screen associated with the system and/or method in accordance with embodiments of the present invention.

FIG. 17 shows a screen shot for an exemplary embodiment of a web page displaying a bond type selection screen associated with the system and/or method in accordance with embodiments of the present invention.

FIG. 18 shows a screen shot for an exemplary embodiment of a web page displaying an investment range screen associated with the system and/or method in accordance with embodiments of the present invention.

FIG. 19 shows a screen shot for an exemplary embodiment of a web page displaying a contact information screen associated with the system and/or method in accordance with embodiments of the present invention.

FIG. 20 shows a screen shot for an exemplary embodiment of a web page displaying a pricing engine query results screen associated with the system and/or method in accordance with embodiments of the present invention.

FIG. 21 shows a screen shot for an exemplary embodiment of a web page displaying a municipal bond details screen associated with the system and/or method in accordance with embodiments of the present invention.

FIG. 22 shows an exemplary embodiment of a flowchart for the system and/or method in accordance with embodiments of the present invention.

FIG. 23 shows an exemplary embodiment of a hardware overview for the system and/or method in accordance with embodiments of the present invention.

FIG. 24 shows an exemplary embodiment of a pricing engine for the system and/or method in accordance with embodiments of the present invention.

FIG. 25 shows an exemplary embodiment of a database associated with the system and/or method in accordance with embodiments of the present invention.

FIG. 26 shows an overview of an embodiment of the system and/or method in accordance with embodiments of the present invention in comparison with the prior art.

FIG. 27 shows an embodiment of an exemplary tax-free guarantee associated with the system and/or method in accordance with embodiments of the present invention.

### DETAILED DESCRIPTION OF THE PREFERRED EMBODIMENTS

The present invention provides a method and apparatus for preparing for sale, selling, and purchasing securities, such as but not limited to municipal bonds, over a network, such as the Internet. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

In an embodiment of the invention, bond prices and yields may be determined based on factors such as but not limited to analysis of trades in the secondary market, adjustments for credit, regional volume, and other variations, in order to determine an appropriate market yield for a particular series of bonds.

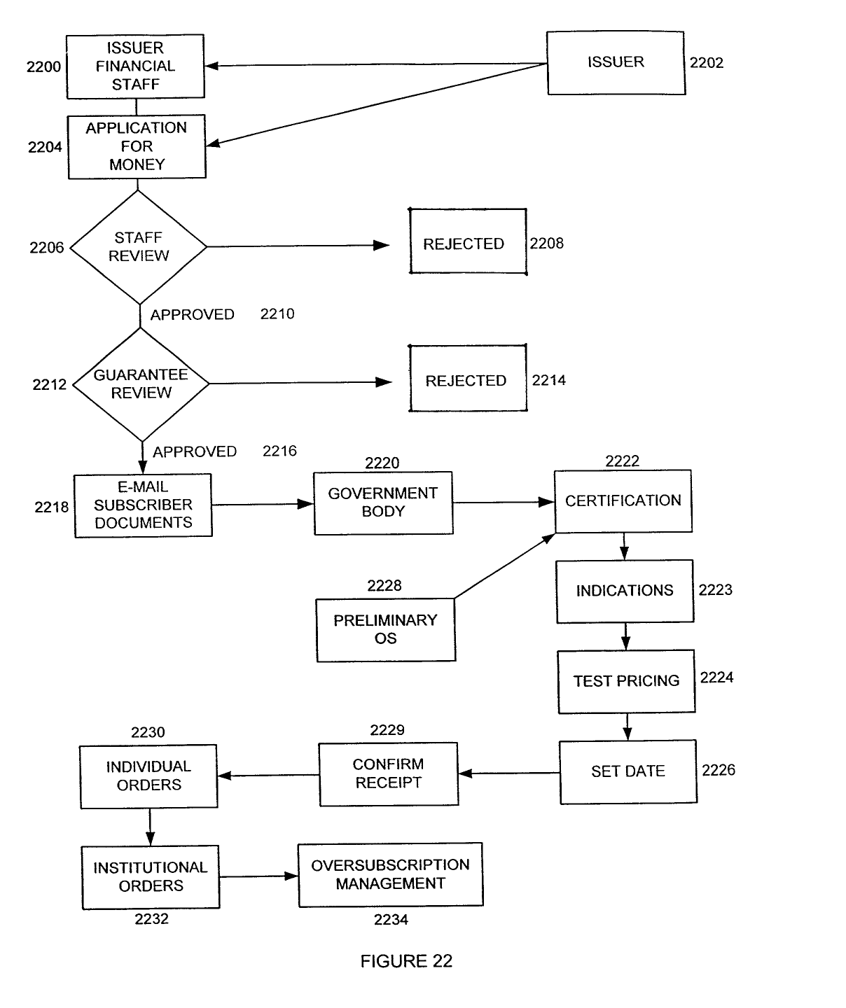

FIG. 22 shows an exemplary embodiment of a flowchart of a process flow for the system and/or method in accordance with embodiments of the present invention. Issuer 2202, such as the City of San Francisco or City of Seattle, in association with issuer financial staff 2200, becomes aware of the municipal bond marketplace pursuant to a brochure sent to them by the system and/or method in accordance with embodiments of the present invention. The system and/or method in accordance with embodiments of the present invention may target a municipal issuer 2202 such as City and County of San Francisco or even a pooled issuer 2202. A pooled issuer may be, for example, an organization such as CSAC, which is the County Association of Counties Of California Counties, which has pooled financings. Even all issuers of bonds in the state of California may be involved by taking a group of counties and pooling them together for an issuance.

The system and/or method in accordance with embodiments of the present invention communicate with a municipal issuer 2202 by providing issuer 2202 with an analysis, for example including prior issues associated with issuer 2202 and the interest rates or prices that would have been achieved for those bonds, or interest rates on their loans, using the system and/or method in accordance with embodiments of the present invention. This analysis may be performed by a munindex pricing engine of the system and/or method in accordance with embodiments of the present invention. In an exemplary embodiment of the invention, the system and/or method in accordance with embodiments of the present invention shows issuer 2202 the amount of money issuer 2202 would have saved in prior issues historically by using the munindex pricing engine of the system and/or method in accordance with embodiments of the present invention.

Issuer 2202 then completes application for money 2204, for example through issuer financial staff 2200, or, for example, a finance staff.

Issuer financial staff 2200 need not be a “major player,” for example with a municipality having a very strong financial staff. Issuer financial staff 2200 may be, for example, one or more quantitatively strong persons working for them. In an embodiment of the invention, a municipality may not have many bond issues each year, so the municipality may hire outside issuer financial staff 2200.

Issuer 2202 may consult internal staff or issuer financial staff 2200. In an embodiment of the invention, an exemplary issuer financial staff 2200 for exemplary entities such as the City of New York and State of California, is PRAG. In an embodiment of the invention, another exemplary issuer financial staff 2200 is Dain Raucher. In an embodiment of the invention, any one or more of hundreds of issuer financial staffs 2200 may be employed by the system and/or method in accordance with embodiments of the present invention.

Issuer 2202 and/or issuer financial staff 2200 may complete application for money 2204, for example after obtaining relevant numbers and securities codes.

In step 2206, a staff review is performed by a staff associated with the system and/or method in accordance with embodiments of the present invention. Another entity may perform staff review 2206. Unlike the prior art, when an issuer 2202, such as a municipality, desires to obtain money, such as through a bond issuance, issuer 2202 or an entity associated with issuer 2202, such as issuer financial staff 2200, may fill out an on-line application 2204. When such an issuer application for money 2204 is reviewed by staff 2206 and is approved 2210, then the system and/or method in accordance with embodiments of the present invention may send one or more brochures to issuer 2202 and/or one or more investors, such as but not limited to individual investors and/or institutional investors. After approval 2210, if issuer 2202 or another entity, such as one or more investors, indicate an interest, the system and/or method in accordance with embodiments of the present invention may help complete a portion or all of any application 2204 or another application. Issuer 2202 may confirm the completed application. By the time the system and/or method in accordance with embodiments of the present invention communicates the one or more brochures to issuer 2202, the system and/or method in accordance with embodiments of the present invention may have placed information relating to application for money 2204 on-line. The system and/or method in accordance with embodiments of the present invention may approve 2210 application 2204 for the top or preferred issuers in the United States. There may only be around 5,000 issuers in the United States. The system and/or method in accordance with embodiments of the present invention has selected the preferred issuers that criteria associated with the system and/or method in accordance with embodiments of the present invention. Exemplary criteria for issuers 2202 used by the system and/or method in accordance with embodiments of the present invention may include such exemplary factors as stability, past credit history, and other factors. The preferred issuers may be the market for the system and/or method in accordance with embodiments of the present invention.

At step 2206, staff associated with the system and/or method in accordance with embodiments of the present invention may reject 2208 an application 2204 for exemplary reasons such as but not limited to an overly risky venture or poor credit history. An example of a risky venture may be a skating rink, as opposed to, for example, a safer venture like a city hall. The system and/or method in accordance with embodiments of the present invention may not accept applications 2204 associated with riskier municipal bonds. Another exemplary risky bond may be one associated with borrowing money to build a new housing subdivision in the middle of a desert. The system and/or method in accordance with embodiments of the present invention may reject applications 2204 from an issuer, such as a municipality, rated A or better, if the application 2204 involves a project having low or uncertain revenues, such as a project for building a swimming pool where the only revenues would come from people going to the pool to pay to swim. Exemplary applications that may be approved 2210 may include applications associated with airports and/or general obligations based on property taxes and water works where revenue streams may be more certain or consistent. Such exemplary applications may have established credit levels. Staff 2206 may reject 2208 if the investment, for example, is speculative or non-investment grade.

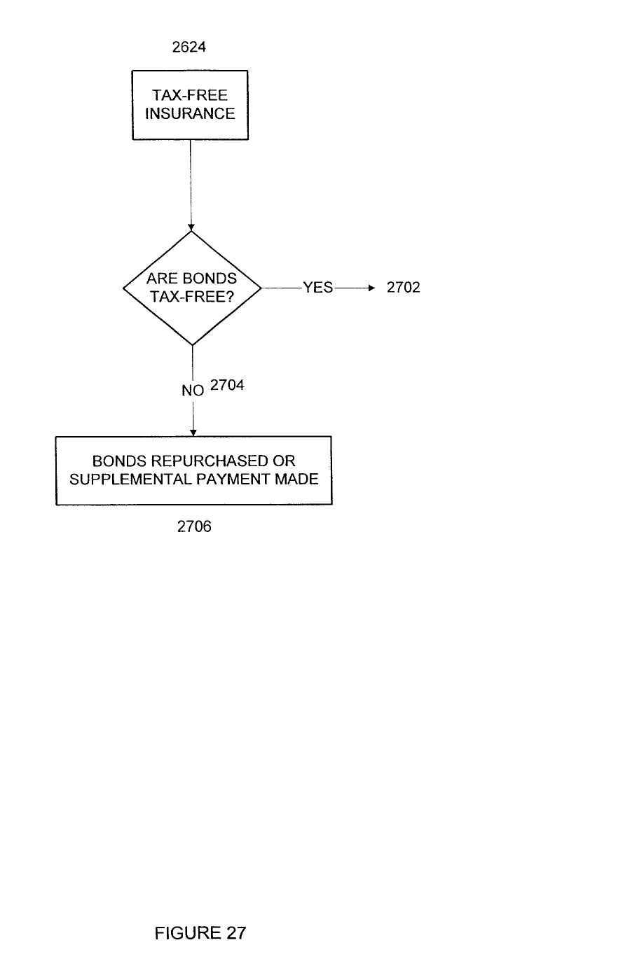

At step 2212, application 204 may be reviewed by one or more bond and/or tax-free guarantee insurers. Such a tax-free insurer may provide tax-free insurance 2624 as shown in FIG. 27.

Based on type of issue and amount of issue indicated by issuer 2202 in application 2204, the system and/or method in accordance with the FIG. 22 embodiment may communicate or send the required standard documents to issuer 2202, for example by e-mailing subscriber documents 2218. In step 2218, the system and/or method in accordance with embodiments of the present invention may send an issuer 2202 via e-mail a secure subscriber number and/or one or more standard documents such as one or more required bond resolutions, one or more bond documents, and one or more forms of an official statement. The standard documents may be annotated and may include an associate resolution to be approved by a governing body associated with issuer 2202. The standard documents, resolution, and or approval requirements may be based on the regulations under state law. In the prior art, a bond counsel opinion would dictate approval requirements. In accordance with the invention, for example, for a county having more than a hundred thousand people to approve a borrowing of money, there may be notice requirements, a waiting period requirement, a first reading requirement, a second reading requirement, a county clerk vote certification requirement, a majority vote requirement, and/or a full forum requirement.

In the prior art, a bond counsel does not personally view meetings. Rather, a bond counsel relies on standard documents. The system and/or method in accordance with embodiments of the present invention is associated with municipal governments that may only act by virtue of express legal authority and may act based strictly upon the law and what the law allows them to do. The system and/or method in accordance with embodiments of the present invention uses the strict legal requirements to adopt a standardized and computerized approach. The system and/or method in accordance with embodiments of the present invention may use standard documents having content that may be well known and established by legal codes. The system and/or method in accordance with embodiments of the present invention may have internal counsel to prepare the standard documents for the system and/or method in accordance with embodiments of the present invention.

Standard documents associated with the system and/or method in accordance with embodiments of the present invention include one or more official statements, one or more bond indentures, one or more county resolutions, one or more municipal board resolutions, one or more actual forms of bond, one or more forms of legal opinion, one or more certificates of the clerk, and one or more other documents. The county resolutions may be associated with a county governing board. The one or more municipal board resolutions may be associated with a municipal governing board that approves the bond issuance. The one or more forms of legal opinion may be associated with one or more of a governing body's attorney, a county attorney, a city attorney, and a state attorney approving and stating that proper approval has been given. The one or more certificates of the clerk may be associated with proof showing that documents are on file in a secure place and showing one or more appropriate stamps displaying approval. Standard documents show a loan agreement, one or more proper approvals, and one or more certificates showing proper filing as a public document. The standard documents may include one or more official statements that describe the associated bond issue, associated security revenues, and other information. An official statement acts as a disclosure document.

As shown in FIG. 22, government body approval takes place in step 2220, and certification occurs in step 2222. In an alternate embodiment, the system and/or method in accordance with embodiments of the present invention may email subscriber documents 2218 to issuer 2202 after government body approval 2220 and certification 2222.

Referring again to FIG. 22, one or more government bodies 2220 may approve the bond issuance or resolution through the use of, for example, two readings. Government body 2220 may have a public reading on the bond issuance or resolution with attached documents pledging assets to secure the loan. Government body 2220 approval may be include a waiting period of, for example, two weeks for people to appear and argue against the resolution. A second reading may be followed by a vote, with a majority vote approving the resolution and the resolution becoming public law, for example an ordinance. An ordinance may be associated with, for example, two readings. A resolution may be associated with one reading. A bond issuance or application may require an ordinance having two readings. A bond issuance or application may require one reading.

After the government body approval 2220, the system and/or method in accordance with embodiments of the present invention may obtain certification 2222, in which the government may send certification of approval. As certification 2222 occurs, the system and/or method in accordance with embodiments of the present invention prepares a preliminary official statement 2228. The system and/or method in accordance with embodiments of the present invention may send preliminary OS 2228 to potential bond purchasers. The system and/or method in accordance with embodiments of the present invention may make the preliminary official statement 2228 available to all potential bond purchasers on-line, such as through a display on a web page, wherein, for example, one or more official statement links exist on the web page. A user, for example a bond purchaser, may click or select one or more of the official statement links to download or view the preliminary official statement 2228. The system and/or method in accordance with embodiments of the present invention presents a web page having information such as but not limited to municipality web pages and associated links, associated documents, associated municipality board on-line meetings and associated links.

After the system and/or method in accordance with embodiments of the present invention sends preliminary official statements 2228 to potential purchasers, potential purchasers may communicate indications of interest 2223 to the system and/or method in accordance with embodiments of the present invention. The indications of interest 2223 may, for example, be on a when as and if issued basis. Indications 2223 may be contingent upon the associated bonds actually being issued, with, for example, the interest capable of being withdrawn should the bonds not issue.

The system and/or method in accordance with embodiments of the present invention may prompt issuer 2202 or an associated party to participate in a test pricing run 2224. Test pricing 2224 may be associated with an exemplary test pricing so that, for example, were the bonds to be sold the day of the test pricing, an appropriate price and/or interest rate may be generated. Test pricing 2224 may be associated with calculations performed by a munindex pricing engine associated with the system and/or method in accordance with embodiments of the present invention. Issuer 2202 during test pricing 2224 may use the subscriber number obtained in e-mail 2218 to obtain access to the system and/or method in accordance with embodiments of the present invention, such as through a login procedure, for example involving a user name and a password. Issuer 2202 during test pricing 2224 may test pricing at two dates for its bond issuance to obtain a test price and/or interest rate.

Test pricing results associated with the system and/or method in accordance with embodiments of the present invention may be communicated to issuer 2202. If issuer 2202 is satisfied and/or comfortable with the results of test pricing 2224, the issuer 2202 or associated entity may set a pricing date 2226. If issuer 2202 decides the interest rate or price associated with results from test pricing 2224 are unacceptable, for example higher than a desired interest, then issuer 2202 may cancel the bond issuance. A munindex pricing engine establishes an objective, appropriate bond price and/or interest race, so issuer 2202 may likely accept results of test pricing 2224 and set date 2226.

Once issuer 2202 sets date 2226, the system and/or method in accordance with embodiments of the present invention confirms the bond issuance. On the set date 2226, issuer 2202 may receive their interest. On set date 2226, the system and/or method in accordance with embodiments of the present invention, for example the munindex pricing engine, sets an interest rate on the bond or loan for issuer 2202. On the set date 2226, the system and/or method in accordance with embodiments of the present invention communicates the interest rate calculated by the system and/or method in accordance with embodiments of the present invention to issuer 2202 and the one or more associated purchasers of the bond issuance.

The system and/or method in accordance with embodiments of the present invention may be applied to any loan system, for example, where issuer 2202 is a borrower and the one or more purchasers are lenders. The bond holders may be the buyers of the bonds or the lenders. The system and/or method in accordance with embodiments of the present invention may relate to a loan to a municipality wherein, for example, one or more bond holders are the lenders, loan participants, and/or buyers of the bonds. Issuer 2202 may be the borrower or the seller of the bond.

Referring again to FIG. 22, set date 2226 may be associated with a pricing date on which, for example, the interest rate or the price of the bond issuance may be set.

The system and/or method in accordance with embodiments of the present invention may contact potential purchasers, for example, buyers, to inform them of the bonds for issue at the time the government sends on-line certification of approval 2222. The system and/or method in accordance with embodiments of the present invention may contact potential purchasers to inform them of the bonds for issue at another time. The system and/or method in accordance with embodiments of the present invention may send to potential purchasers copies of the offering documents, such as but not limited to standard documents. The system and/or method in accordance with embodiments of the present invention may send on-line copies of the offering documents to the potential purchasers.

The bonds that may be for sale may be advertised on a web page associated with the system and/or method in accordance with embodiments of the present invention, for example, such as but not limited to a time proximate to the time of occurrence of certification step 2222.

Potential buyers may access a web page associated with the system and/or method in accordance with embodiments of the present invention and obtain copies of official statements for any bonds that may be available for purchase in the future. The system and/or method in accordance with embodiments of the present invention contains one or more web pages having associated links to local newspapers that cover each bond issue. The system and/or method in accordance with embodiments of the present invention contains one or more web pages having associated links to each bond issuer. A user, such as a potential purchaser, of the one or more web pages associated with the system and/or method in accordance with embodiments of the present invention may download materials from local newspapers or bond issuers and may access web pages associated with local newspapers and bond issuers by clicking or selecting the associated links. The system and/or method in accordance with embodiments of the present invention presents prior official statements of each bond issuer to one or more users, such as one or more potential purchasers and/or issuers. Users may perform credit history research right on one or more web pages associated with the system and/or method in accordance with embodiments of the present invention. The system and/or method in accordance with embodiments of the present invention presents information relating to prior deals and prior credit histories.

One or more web pages associated with the system and/or method in accordance with embodiments of the present invention may display to a user, such as a potential purchaser, secondary market trading histories for each issuer, such as issuer 2202. One or more web pages associated with the system and/or method in accordance with embodiments of the present invention may display to a user comparisons of secondary market trading between issuers. One or more web pages associated with the system and/or method in accordance with embodiments of the present invention may display to a user a general credit history of each issuer. One or more web pages associated with the system and/or method in accordance with embodiments of the present invention may display to a user one or more links to one or more larger issuers. One or more web pages associated with the system and/or method in accordance with embodiments of the present invention may display to a user associated links to one or more newspapers having web pages. One or more web pages associated with the system and/or method in accordance with embodiments of the present invention may display to a user one or more links to one or more newspaper indexes. One or more web pages associated with the system and/or method in accordance with embodiments of the present invention may allow a user to access and/or use one or more newspaper indexes.

Referring again to FIG. 22, at step 2226, an issuer may provide, for example, seven days notice for the associated bond issuance. The system and/or method in accordance with embodiments of the present invention may communicate to potential purchasers or buyers, for example, information indicating seven days notice for the bond issuance corresponding to the date set in step 2226. In an exemplary embodiment of the invention, potential purchasers may communicate indications of interest 2223 to the system and/or method in accordance with embodiments of the present invention, for example, during the same period of time, or, for example, at another time. In an exemplary embodiment of the invention, potential purchasers may communicate indications of interest 2223 over a network, such as the Internet, to a web page associated with the system and/or method in accordance with embodiments of the present invention. A purchaser's indication of interest 2223 may include information relating to the amount of bonds in which the purchaser may be interested in buying. An indication of interest 2223 may be on a when as and if issued basis. In an embodiment of the invention, a when as and if issued basis indication of interest 2223 may relate to announcement by the system and/or method in accordance with embodiments of the present invention, such as through a display on a web page associated with the system and/or method in accordance with embodiments of the present invention, that a bond issue may occur in the future, for example in one month, or, for example, in seven days.

In step 2229, one or more potential bond purchasers may confirm receipt 2229 of a preliminary official statement sent, displayed, or downloaded, for example, in step 2228.

An entity may be prepared to buy the bonds at the index pricing of date 2226 if the transaction is under subscribed, or if the supply of bonds exceeds demand, for example, when the amount of bonds offered by issuer 2202 exceeds the amount of bonds bought by the purchasers. One or more hedge funds may be associated with the system and/or method in accordance with embodiments of the present invention. The one or more hedge funds may purchase any unsold bonds at a set price, for example at the price set on the date selected in step 2226. The system and/or method in accordance with embodiments of the present invention may sell bonds to a hedge fund to be resold in secondary market transactions. In an exemplary embodiment of the invention, a municipal hedge fund may be offered by Franklin Fund, which may either, for example, put together a hedge fund or participate in a hedge fund. Another exemplary entity associated with a hedge fund of the system and/or method in accordance with embodiments of the present invention may be Charles Schwab. The system and/or method in accordance with embodiments of the present invention may eliminate interim costs and create a pricing for bonds that has a cushion compared to a comparable bond in a secondary market.

In order to avoid or minimize posturing and encourage earlier submissions of interest, indications of interest 2223 may be dated or time stamped by the system and/or method in accordance with embodiments of the present invention so that if the bond issuance becomes oversubscribed, for example, parties associated with earlier indications 2223 may be allowed to purchase the bonds before parties who submit their indications 2223 later. The system and/or method in accordance with embodiments of the present invention may permit a pro-rata purchase of bonds based on indications 2223.

As soon as the system and/or method in accordance with embodiments of the present invention receives certification of approval 2222, the system and/or method in accordance with embodiments of the present invention may make a preliminary official statement 2228 available to potential purchasers, for example. Preliminary official statement 2228 may be available on-line, for example through a link on a web site associated with the system and/or method in accordance with embodiments of the present invention. In an embodiment of the invention, preliminary official statement 2228 may not be physically delivered to potential purchasers. The preliminary official statement 2228 may be in draft form as a public document. The preliminary official statement 2228 may be a public document as soon as it is approved in a public meeting.

Potential purchasers may send indications of interest 2223 to the system and/or method in accordance with embodiments of the present invention prior to receipt of a pricing date through the system and/or method in accordance with embodiments of the present invention, for example through a communication over a network, such as the Internet. A potential purchaser may confirm receipt 2229 through a login web site associated with the system and/or method in accordance with embodiments of the present invention, wherein, for example, the potential purchaser enters a user name and/or password to confirm the receipt. Receipt may also be confirmed 2229 by clicking or selecting a link communicated to the potential purchaser over the network, for example, in an e-mail. The system and/or method in accordance with embodiments of the present invention may send a return receipt to the potential buyer for the confirmation 2229. Potential purchasers may include but are not limited to individual purchasers and institutional purchasers. The system and/or method in accordance with embodiments of the present invention may obtain confirmation 2229 from individual purchasers. The system and/or method in accordance with embodiments of the present invention may or may not obtain confirmation 2229 from institutional purchasers.

In an embodiment of the invention, the system and/or method in accordance with embodiments of the present invention does not require a tax opinion due to tax-exempt insurance associated with the system and/or method in accordance with embodiments of the present invention.

Unlike in the prior art, the system and/or method in accordance with embodiments of the present invention may accept individual orders 2230 before the system and/or method in accordance with embodiments of the present invention accepts institutional orders 2232. In an exemplary embodiment of the invention, the system and/or method in accordance with embodiments of the present invention gives individual purchasers a priority in buying bonds in our program over institutional purchasers. A bond price or interest rate for a bond issuance associated with the system and/or method in accordance with embodiments of the present invention may be the same for individual purchasers as for institutional purchasers. Unlike in the prior art, the system and/or method in accordance with embodiments of the present invention take individual orders one day before the system and/or method in accordance with embodiments of the present invention takes institutional orders. One or more individual purchasers may access a bond marketplace, such as but not limited to a marketplace for municipal bonds, select a portfolio of bonds, and purchase the portfolio directly without associating with an established bond fund.

The system and/or method in accordance with embodiments of the present invention creates a checking account for a purchaser of a bond, wherein, for example, interest from the purchase may be deposited into the checking account, and wherein, for example, the purchaser or an entity associated with the purchaser may write checks from the checking account.

The system and/or method in accordance with embodiments of the present invention may calculate an instant pricing of a bond purchaser's portfolio. The system and/or method in accordance with embodiments of the present invention uses an associated munindex pricing engine to perform the instant pricing calculations. To obtain an instant pricing for a given day, the munindex pricing engine may calculate what the portfolio would be worth in the event that all of the portfolio's holdings were sold on that day.

Referring again to FIG. 22, the day after the system and/or method in accordance with embodiments of the present invention accepts orders from individual purchasers 2230, the system and/or method in accordance with embodiments of the present invention may accept institutional orders 2232. The system and/or method in accordance with embodiments of the present invention may accept individual orders within, for example a two-hour time period, and then take both individual and institutional orders within a following four-hour time period. The system and/or method in accordance with embodiments of the present invention may accept orders from individual investors on one day, and then accept orders from institutional investors on a later day.

In an embodiment of the invention, the system and/or method in accordance with embodiments of the present invention employs two-tier pricing, wherein, for example, the system and/or method in accordance with embodiments of the present invention charges a subscription fee for individual orders 2230 different than for institutional orders 2232. In an exemplary embodiment of the invention, an individual purchaser may pay a subscription fee of $3.00 per bond. In an exemplary embodiment of the invention, an institutional purchaser may pay a subscription or transaction fee of $1.50 per bond. In an embodiment of the invention, a subscription fee may be a transaction fee.

The system and/or method in accordance with embodiments of the present invention may allow an individual purchaser to cancel a transaction, such as a bond purchase order. The system and/or method in accordance with embodiments of the present invention may charge a higher transaction fee for an individual purchaser than for an institutional purchaser because of, for example, an increased risk of a transaction cancellation.

The system and/or method in accordance with embodiments of the present invention may be associated with sales of other bond types, such as treasury bonds. In an embodiment of the invention, the system and/or method in accordance with embodiments of the present invention may be associated with sales of other loan types, such as a mortgage loan.

The system and/or method in accordance with embodiments of the present invention may present an on-line secondary market for a securities sale, such as a bond sale, using munindex pricing engine yields. The secondary market sale may occur after an initial offering or issuance sale. The secondary market sale may involve a sale of bonds from entities that purchased the bonds in an earlier initial offering or issuance sale.

The system and/or method in accordance with embodiments of the present invention may sell securities, such as but not limited to municipal bonds, without a tax opinion from a bond counsel. The system and/or method in accordance with embodiments of the present invention may be associated with a legal validity opinion rendered by an issuer of the securities. The system and/or method in accordance with embodiments of the present invention may use in-house counsel and may eliminate the need for bond counsel.

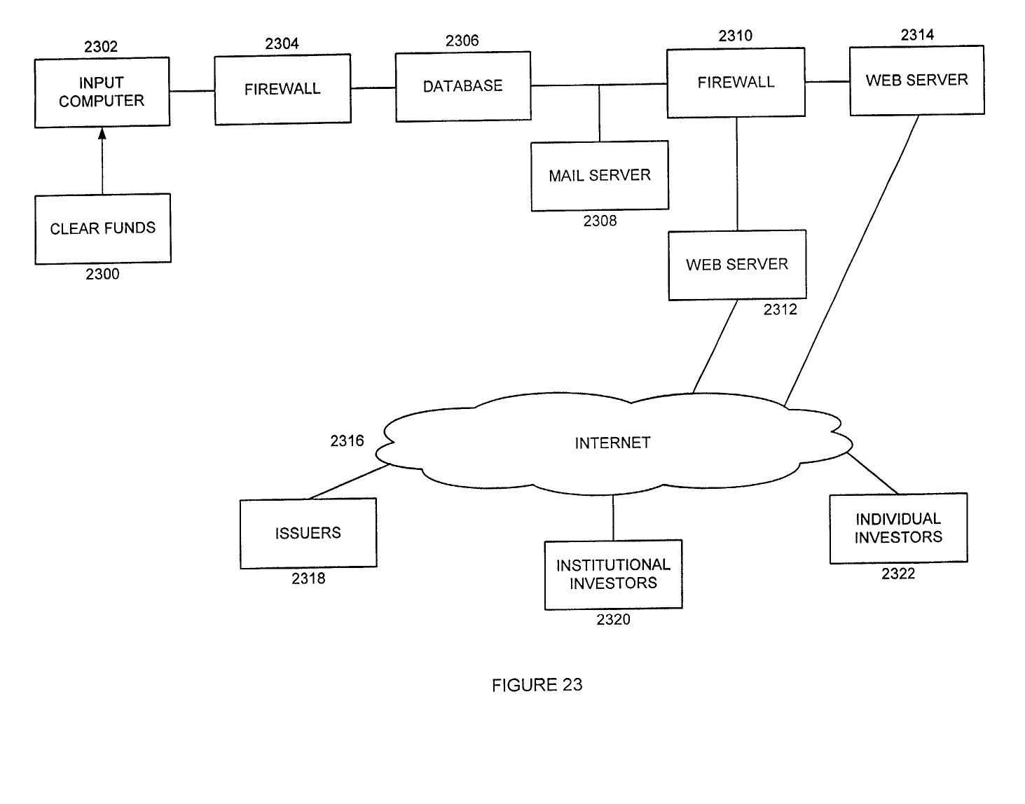

FIG. 23 shows an exemplary embodiment of a hardware configuration associated with the system and/or method in accordance with embodiments of the present invention. When an investor, such as institutional investor 2320 or individual investor 2322 becomes interested in purchasing bonds, for example, a bank may clear funds 2300. An investor may deposit funds directly to an account associated with the system and/or method in accordance with embodiments of the present invention. Input computers 2302 associated with the system and/or method in accordance with embodiments of the present invention are used to enter information into database 2306 after, for example, passing through firewall 2304, which, for example, may perform one or more security checks and/or clearances. A bank may clear funds 2300 electronically when investors 2320 and 2322 purchase bonds.

Information may pass from database 2306 through firewall 2310 to web server 2312 or web server 2314 and to the Internet 2316. Issuers 2318, institutional investors 2320, and individual investors 2322 may connect to the Internet to access web servers 2312 and 2314 associated with the system and/or method in accordance with embodiments of the present invention.

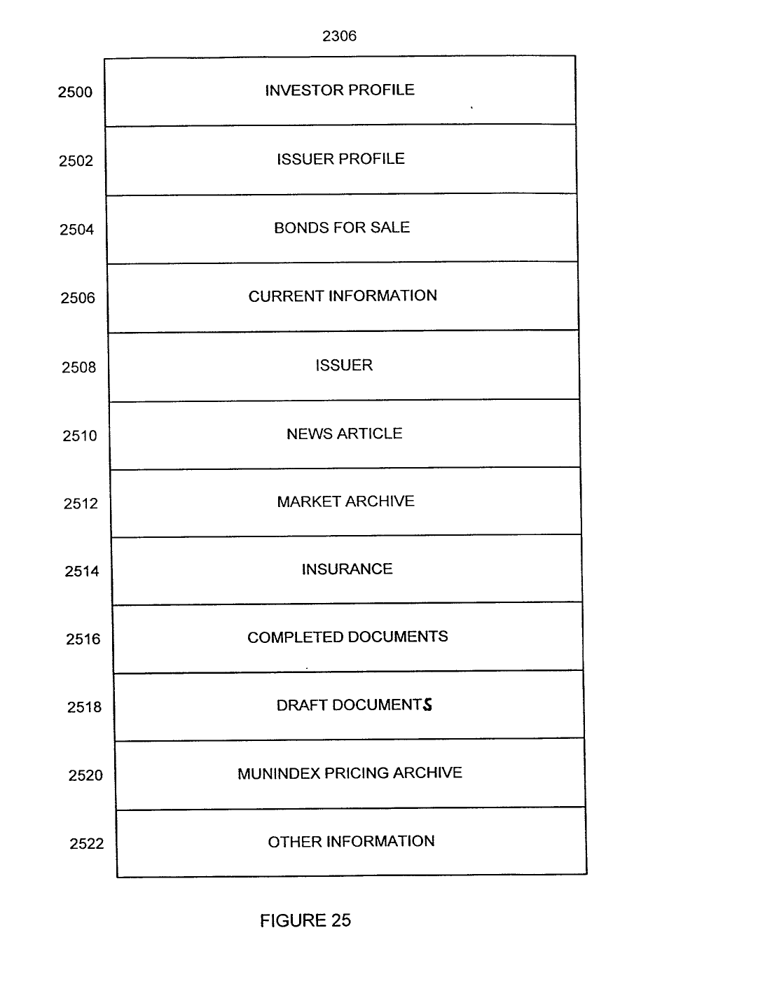

FIG. 25 shows an exemplary structure for database 2306 in more detail. In an embodiment of the invention, database 2306 may include one or more data categories or structures, such as but not limited to investor profile 2500, issuer profile 2502, bonds for sale 2504, current information 2506, issuer 2508, news articles 2510, market archive 2512, insurance 2514, completed documents 2516, draft documents 2518, munindex pricing archive 2520, and other information 2522.

Staff associated with the system and/or method in accordance with embodiments of the present invention may enter information into database 2306. The information may be obtained from sources such as but not limited to newspapers and articles. Staff associated with the system and/or method in accordance with embodiments of the present invention may scan newspaper articles onto a web site associated with the system and/or method in accordance with embodiments of the present invention. The system and/or method in accordance with embodiments of the present invention may display links on a web page associated with the system and/or method in accordance with embodiments of the present invention, wherein, for example, when a user, such as an investor or an issuer, clicks or selects a link associated with a newspaper or article, a web page associated with the selected newspaper or article may be communicated to the user. In an exemplary embodiment of the invention, newspaper links may be associated with newspapers such as the San Francisco Examiner, the San Francisco Chronicle, and/or the L.A. Times. The system and/or method in accordance with embodiments of the present invention coordinates with one or more newspaper companies, wherein the one or more newspaper companies may, for example, communicate information to the system and/or method in accordance with embodiments of the present invention when an article relating to a bond issue arises.

Referring again to FIG. 25, database 2306 may be munindex pricing archive 2520, which may contain munindex pricing engine pricing associated with the system and/or method in accordance with embodiments of the present invention, wherein, for example, test date pricing information may be stored for one or more issuers.

Referring again to FIG. 23, mail server 2308 may send the information to issuer 2318, institutional investors 2320, and individual investors 2322, such as but not limited to a subscriber number, a subscription number, bond sale information, news, documents, updates, and other information. In an embodiment of the invention, the system and/or method in accordance with embodiments of the present invention may invoke mail server 2308 to send information relating to bond resolutions, bond documents, and forms, such as at step 2218 in FIG. 22.

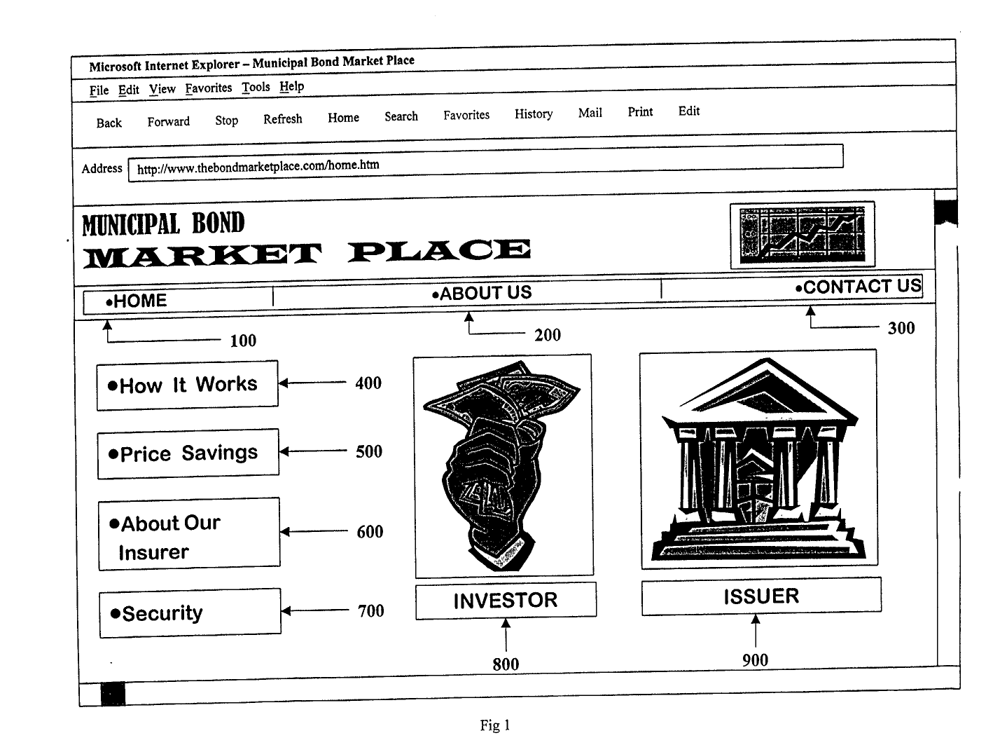

FIGS. 1-21 show exemplary screen shots associated with an embodiment of a bond offering, sale, and management method and system of the present invention. Each screen shot may be associated with one or more web sites associated with exemplary embodiments of the system and/or method in accordance with embodiments of the present invention.

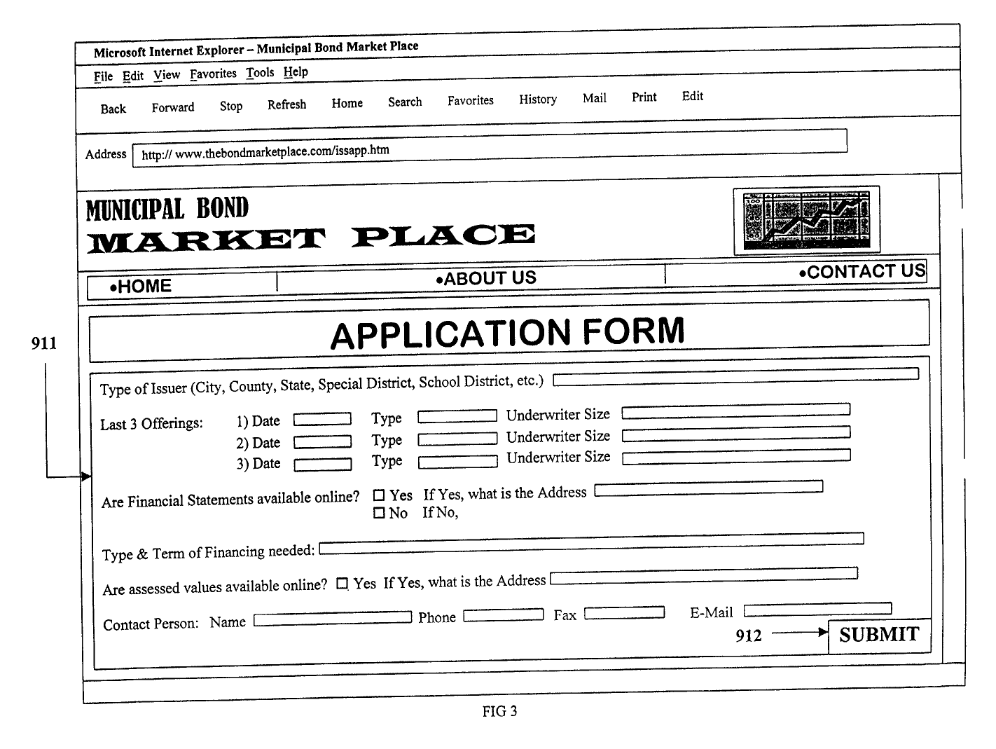

FIG. 3 shows an exemplary application form 911 for an issuer associated with the system and/or method in accordance with embodiments of the present invention. An issuer may be, for example, a city, a county, a unified school district, or another entity.

In an exemplary embodiment of the invention, a purchaser, such as an individual investor or an institutional investor, for example, may make a bond purchase associated with the system and/or method in accordance with embodiments of the present invention by either making a credit card payment or by making a direct bank account transfer. A purchaser may also make a bond purchase by sending to the system and/or method in accordance with embodiments of the present invention a check by mail, credit card information by mail, or credit card information by phone.

An investor may open an account associated with the system and/or method in accordance with embodiments of the present invention and deposit money to the account. After opening the account, the investor may then use the deposited money to purchase bonds. If the cost of purchasing one or more bonds is greater than an amount in an investor's account, the investor may use a margin account to make the purchase, wherein, for example, the investor may have a limited number of days, such as 30, for example, to deposit an additional amount of money into the account, for example, as requested by the system and/or method in accordance with embodiments of the present invention. If the investor fails to make a requested deposit into a margin account, the system and/or method in accordance with embodiments of the present invention may automatically sell bonds previously purchased by the investor to recover any difference.

In an embodiment of the invention, an institutional investor may be, for example, an entity such as E-trade.

FIG. 1 shows an exemplary embodiment of a home page for a web site associated with the system and/or method in accordance with embodiments of the present invention. In an embodiment of the invention, there are seven triggers, or selectable links. Exemplary links may include HOME 100, ABOUT US 200, CONTACT US 300, HOW IT WORKS 400, PRICE SAVINGS 500, ABOUT OUR INSURER 600, SECURITY 700, INVESTOR 800, AND ISSUER 900.

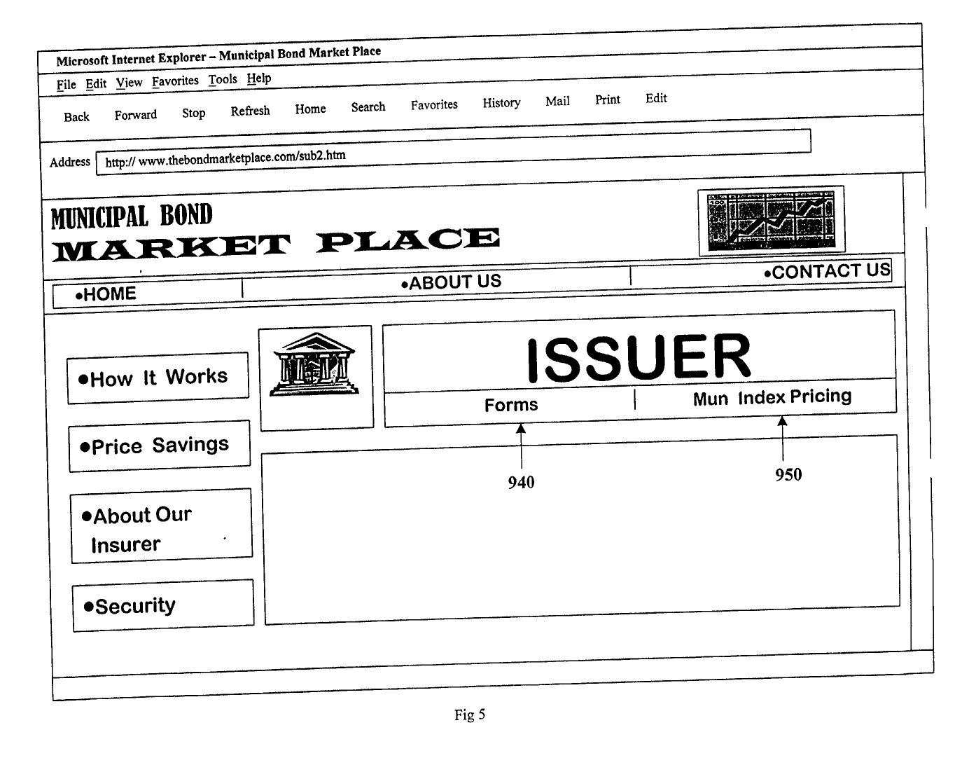

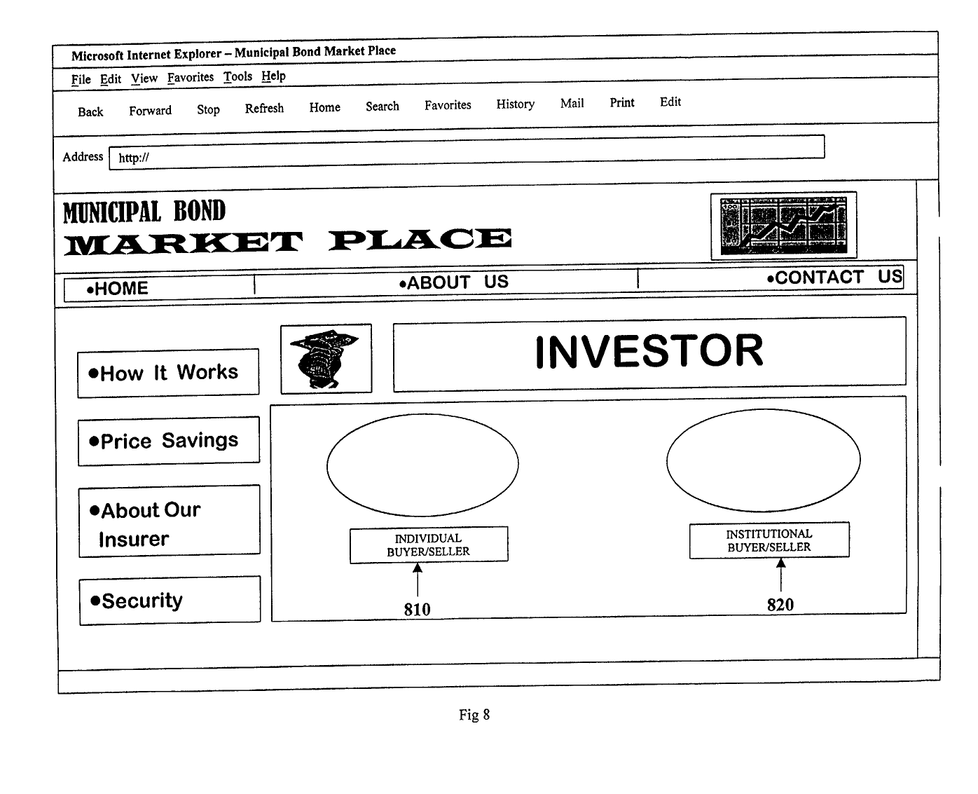

The system and/or method in accordance with embodiments of the present invention may use one or more cookies to memorize one or more pieces of data associated with login information or identification for a user associated with the system and/or method in accordance with embodiments of the present invention. In an embodiment of the invention, when the user accesses a home page such as the one shown in FIG. 1, the system and/or method in accordance with embodiments of the present invention may use the one or more cookies to identify the user and immediately communicate an investor web page, such as the exemplary web page shown in FIG. 8, to the user if the system and/or method in accordance with embodiments of the present invention associates the user with an investor. When the user accesses a home page such as the one shown in FIG. 1, the system and/or method in accordance with embodiments of the present invention may use the one or more cookies to identify the user and immediately communicate an issuer web page, such as the exemplary web page shown in FIG. 5, to the user if the system and/or method in accordance with embodiments of the present invention associates the user with an issuer.

Referring again to FIG. 1, if a user, such as an issuer or an investor, clicks or selects HOME 100, the system and/or method in accordance with embodiments of the present invention may communicate to the user a web page such as the one shown in FIG. 1.

In an embodiment of the invention, if a user clicks or selects ABOUT US 200, the system and/or method in accordance with embodiments of the present invention may communicate to the user an informational web page that may describe the type of institution associated with the system and/or method in accordance with embodiments of the present invention. In an embodiment of the invention, the informational web page may contain information relating to a business plan associated with the system and/or method in accordance with embodiments of the present invention. In an embodiment of the invention, the informational web page may describe the system and/or method in accordance with embodiments of the present invention, how the system and/or method in accordance with embodiments of the present invention works, how the system and/or method in accordance with embodiments of the present invention reduces costs, advantages of the system and/or method in accordance with embodiments of the present invention over the prior art, background relating to the system and/or method in accordance with embodiments of the present invention, entities supporting the system and/or method in accordance with embodiments of the present invention, and/or how the system and/or method in accordance with embodiments of the present invention was created. In an embodiment of the invention, if a user clicks or selects ABOUT US 400, the system and/or method in accordance with embodiments of the present invention may communicate to the user information relating to the history of the system and/or method in accordance with embodiments of the present invention, such as but not limited to the history about a company associated with the system and/or method in accordance with embodiments of the present invention.

Referring again to FIG. 1, if a user clicks or selects CONTACT US 300, contact information, such as phone numbers, addresses, and e-mails, may be communicated to the user. If a user clicks or selects HOW IT WORKS 400, the system and/or method in accordance with embodiments of the present invention may communicate to the user detailed information relating to, for example, navigating the one or more web sites associated with the system and/or method in accordance with embodiments of the present invention and how the system and/or method in accordance with embodiments of the present invention works. If a user clicks or selects HOW IT WORKS 400, the system and/or method in accordance with embodiments of the present invention may communicate to the user how the system and/or method in accordance with embodiments of the present invention may save money for the user, how the system and/or method in accordance with embodiments of the present invention may reduce costs by cutting out middlemen, such as but not limited to bond counsel, tax counsel, and other entities. If a user clicks or selects HOW IT WORKS 400, the system and/or method in accordance with embodiments of the present invention may communicate to the user how the system and/or method in accordance with embodiments of the present invention may reduce paperwork associated with the traditional municipal market, such as paperwork between issuers and investors.

Referring again to exemplary FIG. 1, if a user clicks or selects PRICE SAVINGS 500, then the system and/or method in accordance with embodiments of the present invention may communicate to the user price information, such as but not limited to one or more examples of pricing for bonds for a given day, for example, the purchase price of one or more bonds if purchased through the system and/or method in accordance with embodiments of the present invention.

Referring again to FIG. 1, if the user clicks or selects ABOUT OUR INSURER 600, the system and/or method in accordance with embodiments of the present invention may communicate to the user insurance information relating to an explanation of one or more insurers associated with the system and/or method in accordance with embodiments of the present invention. In an embodiment of the invention, the insurance information may include such information as an insurer's name, an insurer's tax-free guarantee clause, the insurer's company history, and/or other information related to the insurer.

In an embodiment of the invention, if the user clicks or selects SECURITY 700, the system and/or method in accordance with embodiments of the present invention may communicate to the user security information, such as but not limited to information relating to a policy of not selling, stealing, or improperly using user information. In an embodiment of the invention, the security information may also relate to protections against attempts to hack into web sites associated with the system and/or method in accordance with embodiments of the present invention.

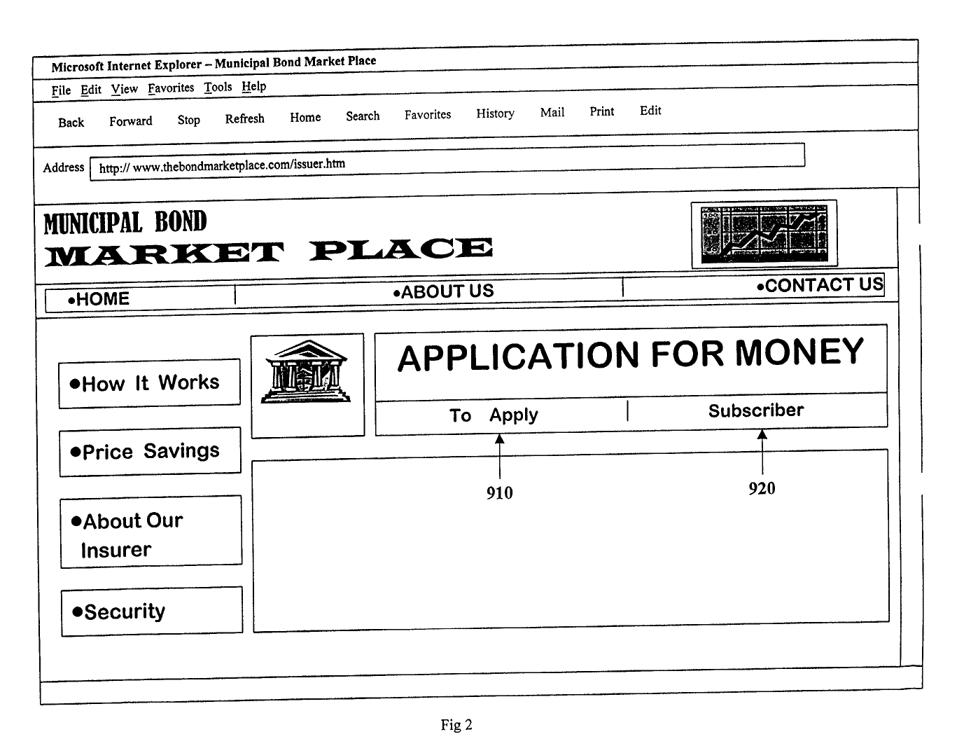

If a user, such as but not limited to an issuer, clicks or selects ISSUER 900 the system and/or method in accordance with embodiments of the present invention may communicate to the user a web site such as the one shown in the exemplary screen shot in FIG. 2.

Referring to exemplary FIG. 2, if a user clicks or selects APPLY 910, a screen shot such as but not limited to the one shown in exemplary FIG. 3 may be communicated to the user. Referring to FIG. 3, the system and/or method in accordance with embodiments of the present invention may prompt the user to fill out exemplary APPLICATION FORM 911, which may request information such as but not limited to type of issuer, last three offerings, whether financial statements are available on-line, a type and term of financing needed, whether assessed values are available on-line, contact person information, and other information. Type of issuer may include, for example, a city, a county, a state, a special district, a school district, or another entity. The last three offerings may include information relating to date, type, and underwriter size. If the user responds “yes” to whether financial statements are available on-line, the system and/or method in accordance with embodiments of the present invention may prompt the user to enter a URL or web address associated with a location for the financial statements. An exemplary type and term of financing related may relate to a set of computers, a new library, new pipelines for a water district, a new facility, a new building, a new ballpark, a city hall construction, a city hall refurbishment, a statue remake, or another type of financing sought. An exemplary term of financing may be three years, seven years, thirty years, or another length of time.

Referring again to APPLICATION FORM 911 in FIG. 3, the system and/or method in accordance with embodiments of the present invention may prompt the user for contact person information, which may include, for example, a name, a phone number, a fax number, and/or an e-mail address. If the user clicks or selects SUBMIT 912, the data entered into APPLICATION FORM 911 may be submitted to the system and/or method in accordance with embodiments of the present invention for approval. If the system and/or method in accordance with embodiments of the present invention approves the application, the application may then be submitted to an insurer. In an embodiment of the invention, the insurer determine whether the application is approved for a tax free guarantee.

Presently in the prior art all tax-exempt bond sales include a bond counsel opinion during the bond sale process. The bond counsel opinion states that the bonds are exempt from federal and state income taxes. Unlike in the prior art, an insurer, such as but not limited to a AAA-rated insurance company, may agree to guarantee that a bond sale associated with the system and/or method in accordance with embodiments of the present invention contains bonds that are tax-exempt. If the IRS determines that the bonds are not tax exempt, the insurer may either repurchase the bonds or pay investors purchasing the bonds a taxable equivalent rate, or an amount sufficient to cover or reimburse the investors for the costs of the taxes.

The system and/or method in accordance with embodiments of the present invention may attach to each bond an insurance tax free guarantee certificate. Investors purchasing bonds through the system and/or method in accordance with embodiments of the present invention obtain a tax-free guarantee instead of a bond opinion. Bonds investor associated with the system and/or method in accordance with embodiments of the present invention may never see a bond opinion. The tax free guarantee may be better than a prior art bond opinion because if bonds using the prior art bond opinion are determined to be taxable, there would be no remedy in the prior art other than a class action lawsuit or a personal action against the bond counsel and/or its professional liability insurance company.

Referring again to FIG. 2, a user, such as an issuer, may APPLY 920 in order to begin an approval process for an application for money. After approving a user, the system and/or method in accordance with embodiments of the present invention may send the user a subscriber number, for example via an approval email. The e-mail may include a link. Upon clicking or selecting the link, the system and/or method in accordance with embodiments of the present invention may communicate to the user a web page such as the one shown in exemplary FIG. 2, so that the user may directly access the screen shown in FIG. 2 without first having to access the screen shown in exemplary FIG. 1. The user may also access a screen such as but not limited to the one shown in exemplary FIG. 2 by first clicking or selecting ISSUER 900 in FIG. 1.

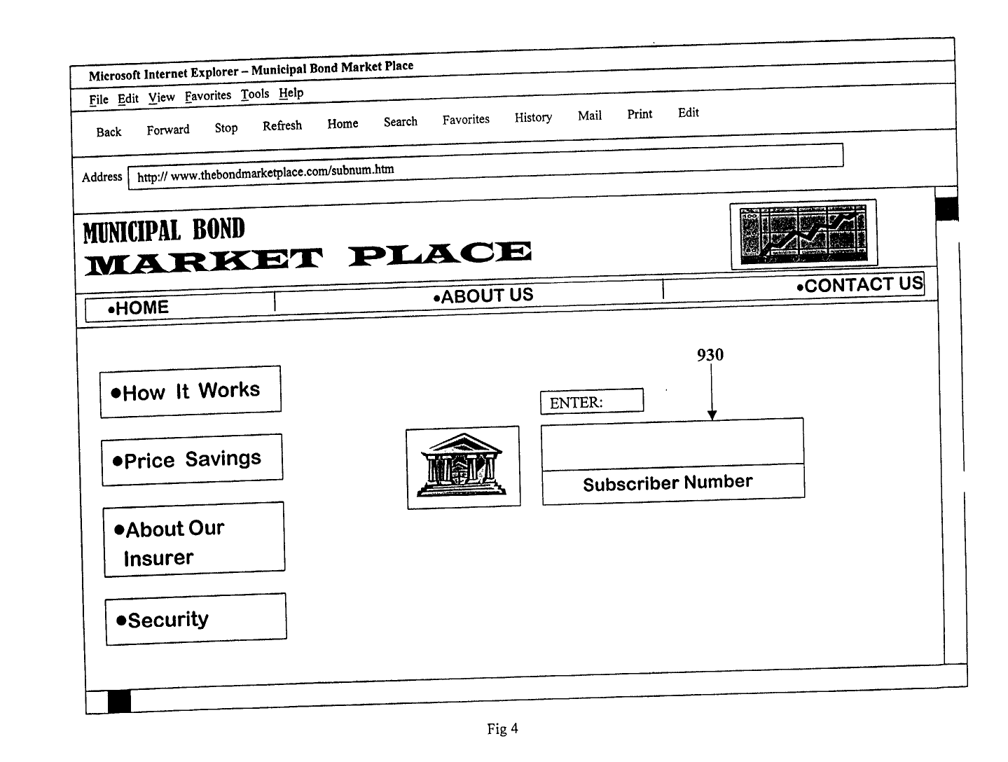

If the system and/or method in accordance with embodiments of the present invention does not approve the application, it may communicate to the issuer a full explanation of why the application did not meet the standards of the system and/or method in accordance with embodiments of the present invention. If the application is approved, and after the system and/or method in accordance with embodiments of the present invention has completed the approval process, the system and/or method in accordance with embodiments of the present invention may then communicate to the issuer a subscriber number, such as but not limited to via e-mail. In an embodiment of the invention, the e-mail may contain a direct link. If the user clicks or selects the direct link, a web page such as the one shown in exemplary FIG. 4 may be communicated to the user. In an embodiment of the invention, after an issuer has received a subscriber number, a corresponding e-mail may contain a link whereby clicking or selecting that link allows the issuer to view an issuer login web site as exemplified by FIG. 4.

Referring to the issuer login web site exemplified by FIG. 4, the system and/or method in accordance with embodiments of the present invention may prompt a user, such as an issuer, to enter a SUBSCRIBER NUMBER 930.

After entering SUBSCRIBER NUMBER 930 in FIG. 4, the system and/or method in accordance with embodiments of the present invention may communicate to the user a web page as shown in the exemplary issuer screen shot in FIG. 5. In an embodiment of the invention, the issuer screen shot in FIG. 5 may contain, for example, FORMS 940 and MUNINDEX PRICING 950. If the user clicks or selects FORMS 940, the system and/or method in accordance with embodiments of the present invention may transmit to the user forms that need to be approved by a relevant government body. The user may download the forms, print the forms from a web site, or view the forms, for example, directly on a web site associated with the system and/or method in accordance with embodiments of the present invention. The system and/or method in accordance with embodiments of the present invention may communicate the forms or representations of the forms in a PDF format. The system and/or method in accordance with embodiments of the present invention may also include a PDF program to view the forms. The system and/or method in accordance with embodiments of the present invention may prompt the user to fill in the forms on-line, and then print out the completed forms.

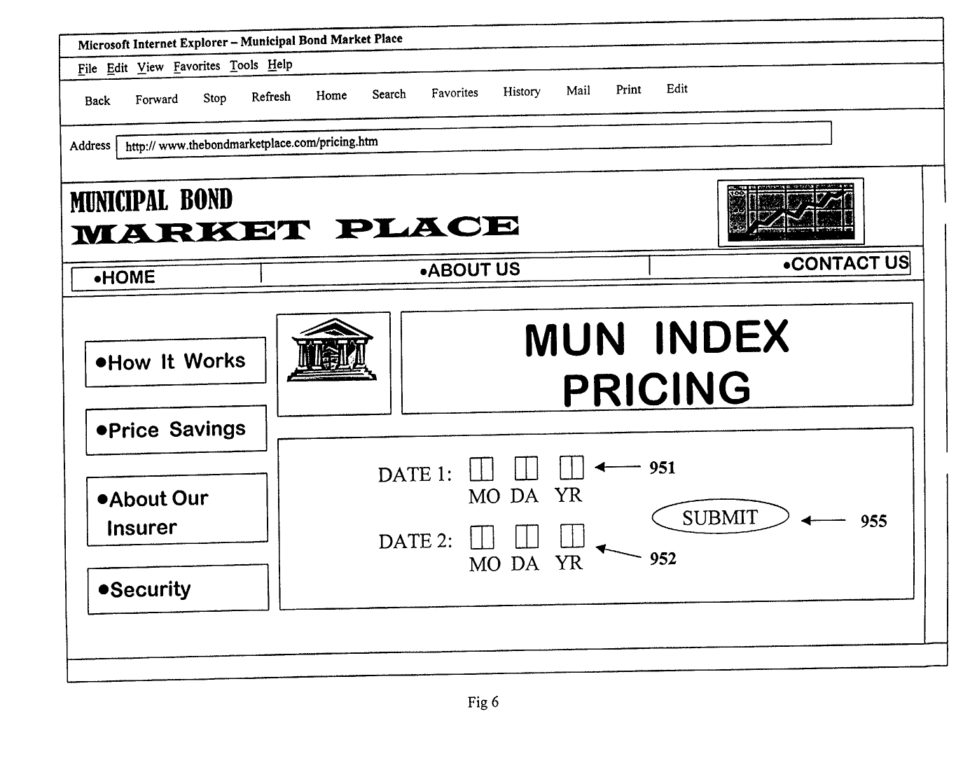

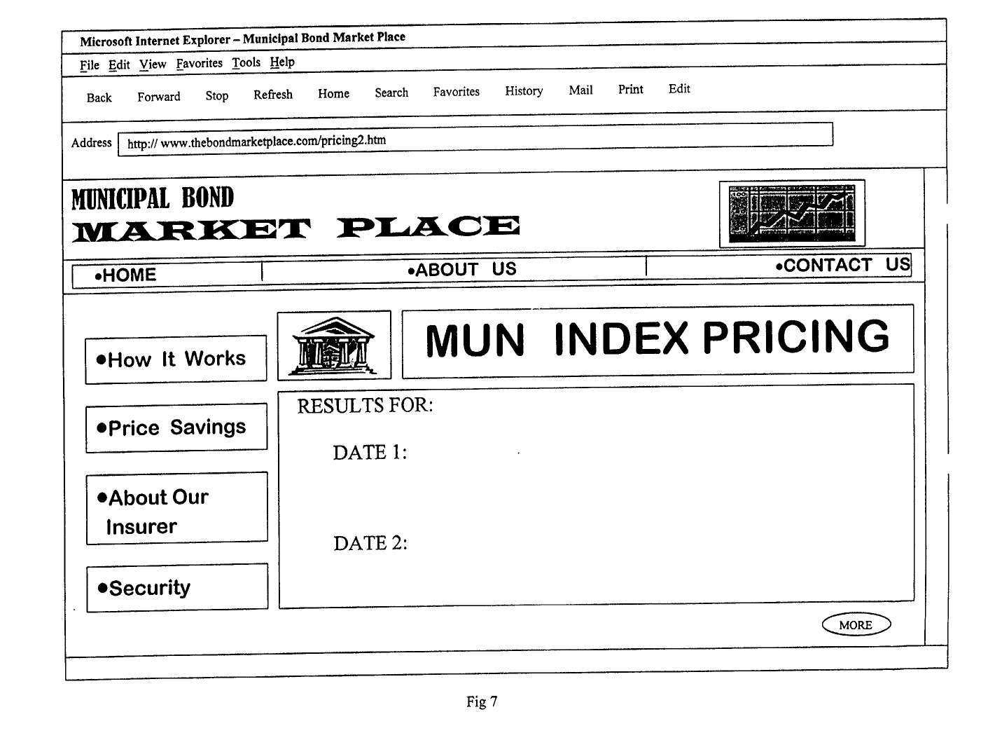

In an embodiment of the invention, referring again to FIG. 5, if the user clicks or selects munindex pricing 950, the system and/or method in accordance with embodiments of the present invention may then communicate to the issuer a web page such as, but not limited to, the one exemplified in FIG. 6. Referring to FIG. 6, a user, such as the issuer, may test, for example, two pricing date runs via DATES 951 and 952. The issuer may enter DATES 951 and 952, and then upon clicking or selecting SUBMIT 955, the system and/or method in accordance with embodiments of the present invention may use the munindex pricing engine to calculate bond prices for DATES 951 and 952. A web page such as the one shown in exemplary FIG. 7 may be communicated to the user. FIG. 7 may display results of the munindex pricing engine pricing calculations to the user.

Munindex pricing engine pricing may invoke database 2306 in FIG. 23, in addition to other methods and processes of the system and/or method in accordance with embodiments of the present invention. The system and/or method in accordance with embodiments of the present invention may retrieve from database 2306 pricing information for the dates chosen by the user in DATES 951 and 952 in FIG. 6. Pricing information may have previously been calculated by the munindex pricing engine associated with the system and/or method in accordance with embodiments of the present invention and stored in database 2306 or another database.

Referring again to FIG. 7, munindex pricing engine prices as retrieved by the system and/or method in accordance with embodiments of the present invention may be displayed to the user. The displayed information may include price per bond, interest rate, yield, and other information.

After a user submits a subscriber number to the system and/or method in accordance with embodiments of the present invention, the system and/or method in accordance with embodiments of the present invention retrieves subscriber-specific information, such as but not limited to type of issue and duration of issue information, and uses the subscriber-specific information to perform an appropriate type of pricing, the results of which may be displayed to the user, for example in a web page as exemplified by the screen shot in FIG. 7.

The system and/or method in accordance with embodiments of the present invention displays pricing based on a generic index and interest rate, such as but not limited to information found through an entity such as Thompson Financials.

A user, such as but not limited to the issuer, may then communicate a pricing date to the system and/or method in accordance with embodiments of the present invention. For example, a government entity may send an on-line certification of approval either before or after the user selects testing dates. The system and/or method in accordance with embodiments of the present invention may at an earlier or later time, sending e-mails to potential investors, wherein the emails may describe approval of the bond issue and a pending sale. One or more web sites associated with the system and/or method in accordance with embodiments of the present invention may display all such related information.

Referring again to FIG. 1, if the user clicks or selects INVESTOR 800, a web page such as one embodied in the exemplary screen shot in FIG. 8 may be communicated to the user. In an embodiment of the invention, the user, such as but not limited to an investor, may select INDIVIDUAL 810 if the user is, for example, an individual investor or INSTITUTIONAL 820 if, for example, the user is an institutional investor.

The system and/or method in accordance with embodiments of the present invention checks user identity by use of, for example, a user name and a password. An institutional investor may be charged a lower transaction fee for a bond purchase than an individual investor is charged for a bond purchase, so the system and/or method in accordance with embodiments of the present invention may perform identification checking to verify that an institutional investor, for example, is truly an institutional investor.

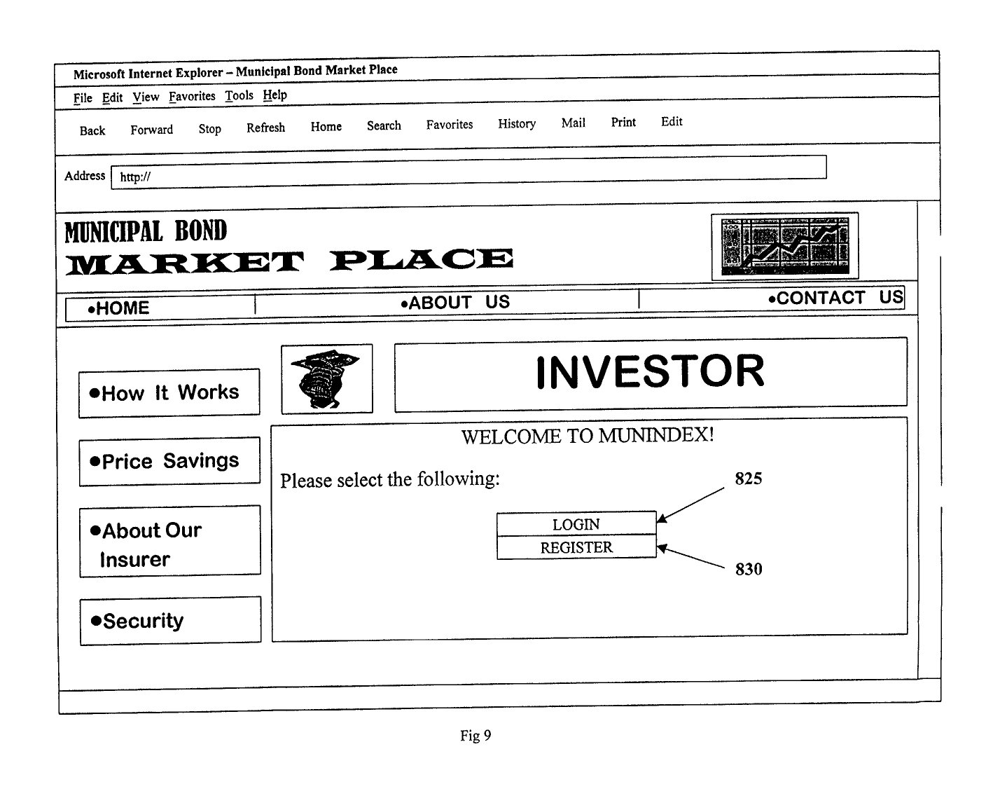

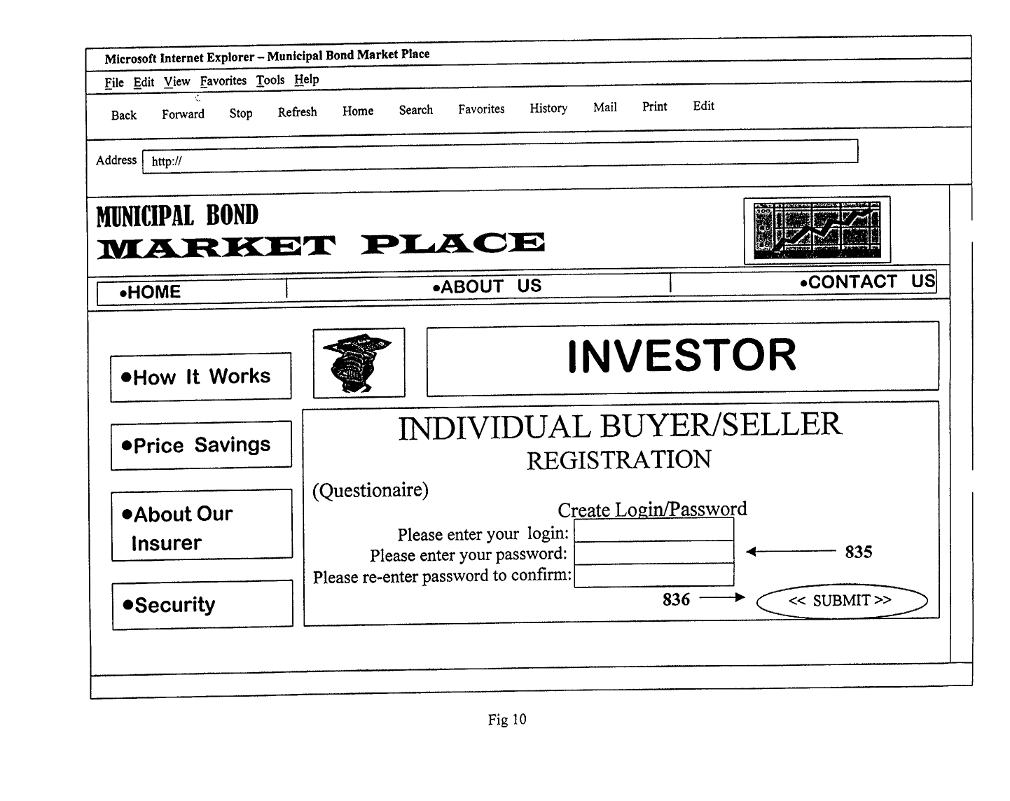

Upon appropriate identification checking, the system and/or method in accordance with embodiments of the present invention may communicate to the user, for example an investor, a web site as exemplified by FIG. 9 to LOGIN 825 or REGISTER 830. REGISTER 830 may be used by an investor to open an account. If an investor clicks or selects register 830 the investor may open an account, for example, with the system and/or method in accordance with embodiments of the present invention communicating to the investor a web site such as the one exemplified by the screen shot in FIG. 10.

Referring to FIG. 10, a user, such as an individual investor, may complete APPLICATION 835 by entering items that may include, for example, a login, a password, a confirmation of the password, and other information. Other information may include, for example, an e-mail address, a physical or mailing address, a telephone number, one or more account numbers and one or more related financial institutions, wherein the user may transfer money from the one or more accounts to the system and/or method in accordance with embodiments of the present invention in the future. The user may write checks from a user account associated with the system and/or method in accordance with embodiments of the present invention, for example, after depositing finds into the account or after selling certain bonds. The system and/or method in accordance with embodiments of the present invention creates a brokerage account for the user. The system and/or method in accordance with embodiments of the present invention prompts the user to enter personal information, such as a social security number, a drivers license, a mother's maiden name, and other information, in order to create the brokerage account. The user may use the brokerage account to purchase and sell bonds and manage a bond portfolio. A user such as but not limited to an institutional investor, may also create a brokerage account. The system and/or method in accordance with embodiments of the present invention may prompt an institutional investor to enter institution information, such as but not limited to a federal ID number and other information, in order to open the brokerage account.

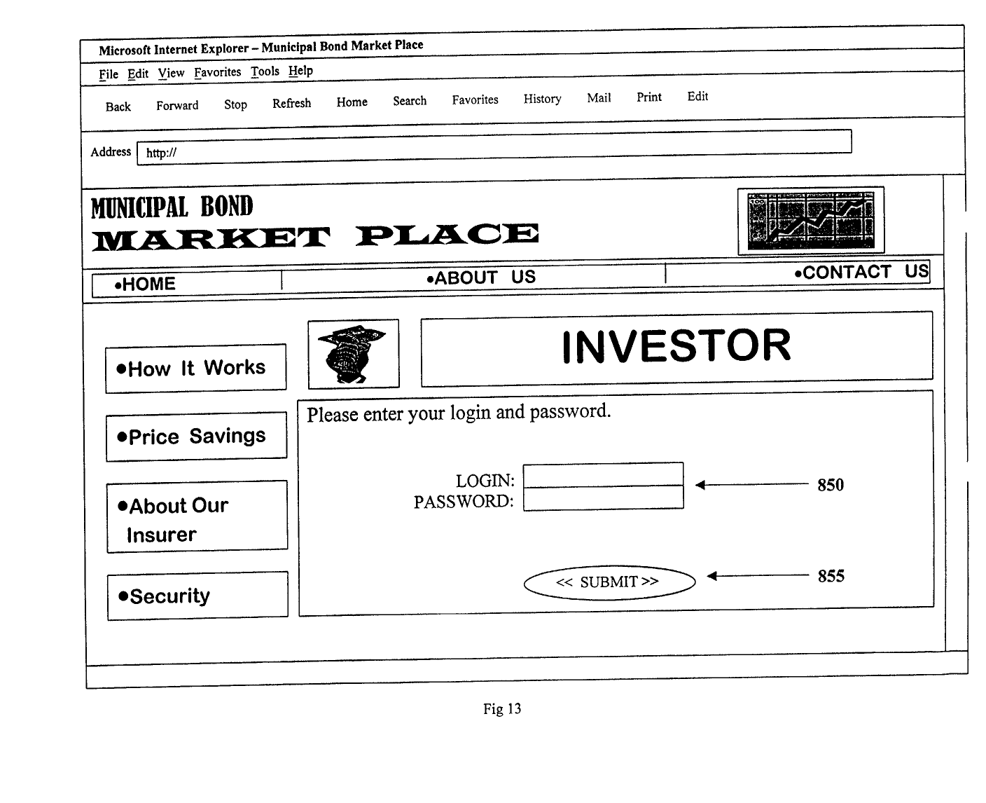

Upon standard or appropriate identification and error checking of the entered registration information, the system and/or method in accordance with embodiments of the present invention may open an investor account. Referring again to FIG. 10, after the user has entered information in APPLICATION 835, the user may click or select SUBMIT 836 in order to communicate the information to the system and/or method in accordance with embodiments of the present invention. Referring again to FIG. 9, after the system and/or method in accordance with embodiments of the present invention approves and opens an account for an investor, such as but not limited to an individual investor, if the investor clicks or selects LOGIN 825, the system and/or method in accordance with embodiments of the present invention may recognize that the investor is an individual investor, for example through the use of cookies. The system and/or method in accordance with embodiments of the present invention may communicate to the user a login web page, such as but not limited to the one shown by the exemplary screen shot shown in FIG. 13. The system and/or method in accordance with embodiments of the present invention may also communicate to the user a web page such as but not limited to the one shown by exemplary screen shot shown in FIG. 10.

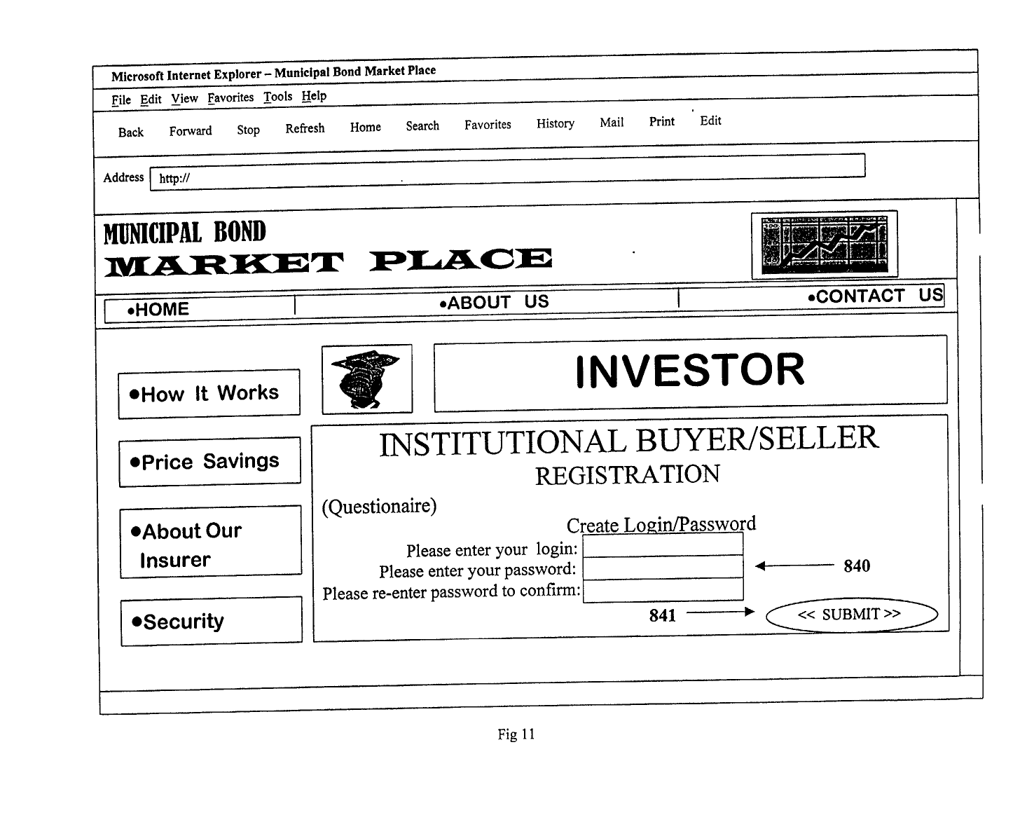

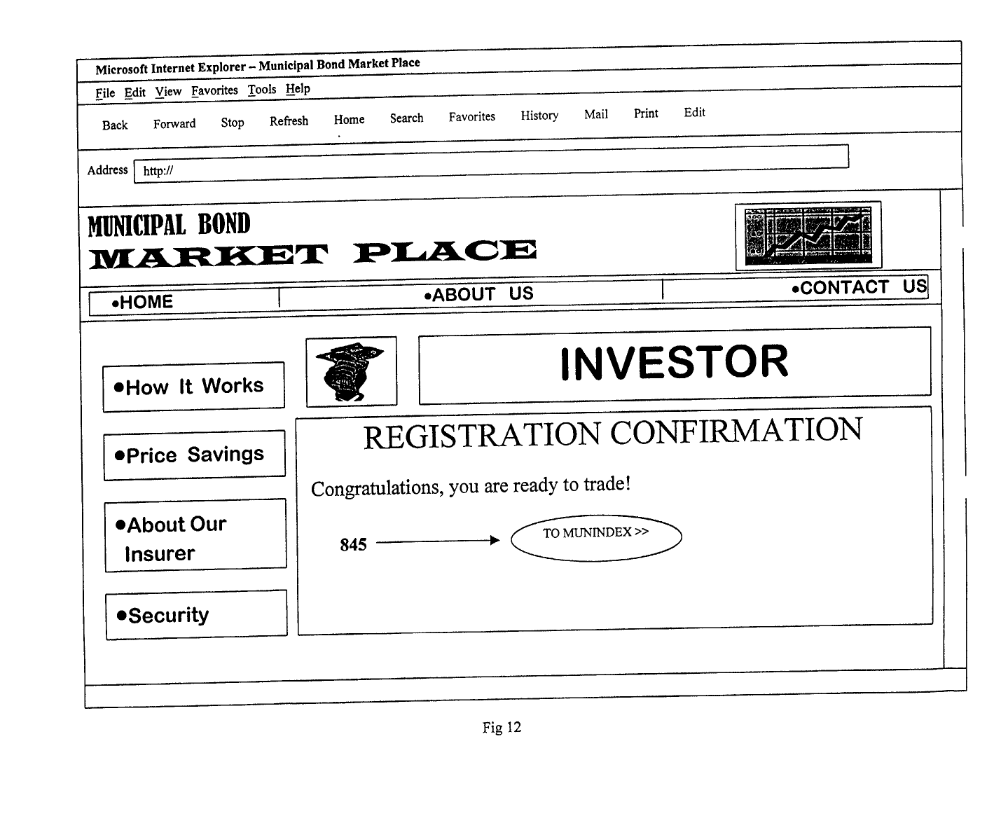

Referring again to FIG. 8, if the user clicks or selects INSTITUTIONAL 820, then the system and/or method in accordance with embodiments of the present invention may communicate to the user a web page such as the one shown in the exemplary institutional buyer/seller registration page screen shot in FIG. 11. The system and/or method in accordance with embodiments of the present invention prompts the user to enter information such as but not limited to a login, a password, and a password confirmation in APPLICATION 840. After the user enters information in APPLICATION 840, the user, such as but not limited to an institutional investor, may click or select SUBMIT 841. If the user clicks or selects SUBMIT 841, the system and/or method in accordance with embodiments of the present invention receives the information entered in APPLICATION 840, and the system and/or method in accordance with embodiments of the present invention may perform identification checking and request information from the user for the identification checking. If the system and/or method in accordance with embodiments of the present invention approves APPLICATION 840, the system and/or method in accordance with embodiments of the present invention may communicate to the user a confirmation web page such as but not limited to the one embodied in the exemplary screenshot shown in FIG. 12.

After the system and/or method in accordance with embodiments of the present invention performs identification checking, for example after the user clicks or selects SUBMIT 836 in FIG. 10 or SUBMIT 841 in FIG. 11, the system and/or method in accordance with embodiments of the present invention may communicate to the user a confirmation web page such as but not limited to the one embodied in the exemplary screenshot shown in FIG. 12.

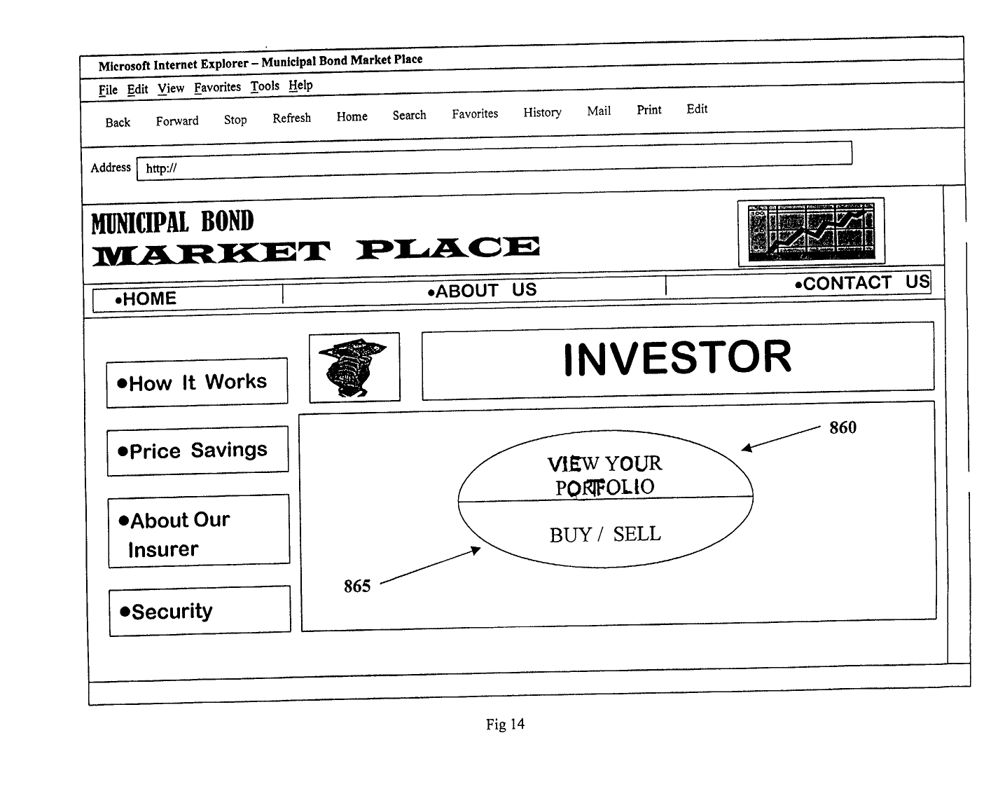

In an embodiment of the invention, referring to FIG. 12, if the user clicks or selects TO MUNINDEX 845, the system and/or method in accordance with embodiments of the present invention may communicate to the user a login web page such as but not limited to the one embodied in the exemplary screenshot shown in FIG. 13. The user, such as but not limited to an investor, enter LOGIN INFORMATION 850. The user may then click or select SUBMIT 855 to communicate the entered LOGIN INFORMATION 850 to the system and/or method in accordance with embodiments of the present invention. The system and/or method in accordance with embodiments of the present invention performs identification and/or error checking. If the identification and/or error checking succeeds, the system and/or method in accordance with embodiments of the present invention may communicate to the user a selection web page such as but not limited to the one embodied in the exemplary screenshot in FIG. 14.

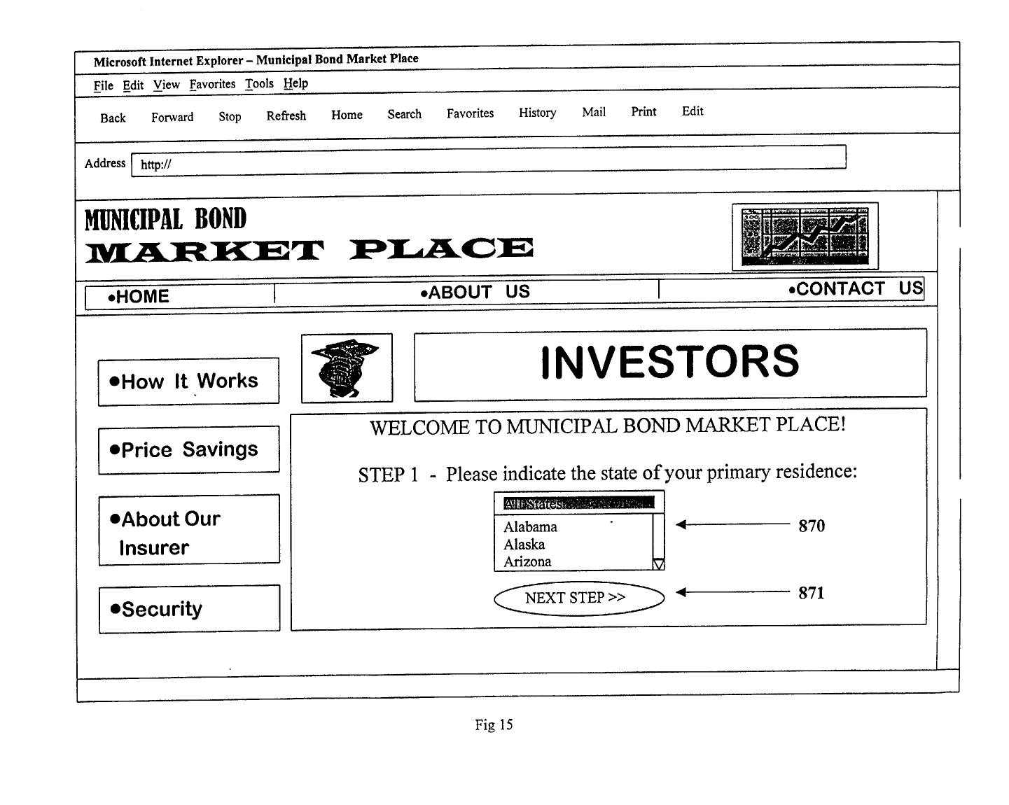

Referring to FIG. 14, the user, such as but not limited to an investor, may click or select VIEW PORTFOLIO 860 or BUY/SELL 865. If the investor selects BUY/SELL 865, the system and/or method in accordance with embodiments of the present invention may communicate to the user a municipal bond marketplace web page such as but not limited to the one embodied in the exemplary screenshot shown in FIG. 15.

Referring to FIG. 15, the system and/or method in accordance with embodiments of the present invention may prompt the user to select one or more STATES 870. The system and/or method in accordance with embodiments of the present invention may present a choice of one or more of the 50 states in the United States to the user in STATES 870, which may include California, Florida, Texas, New York, and other states.

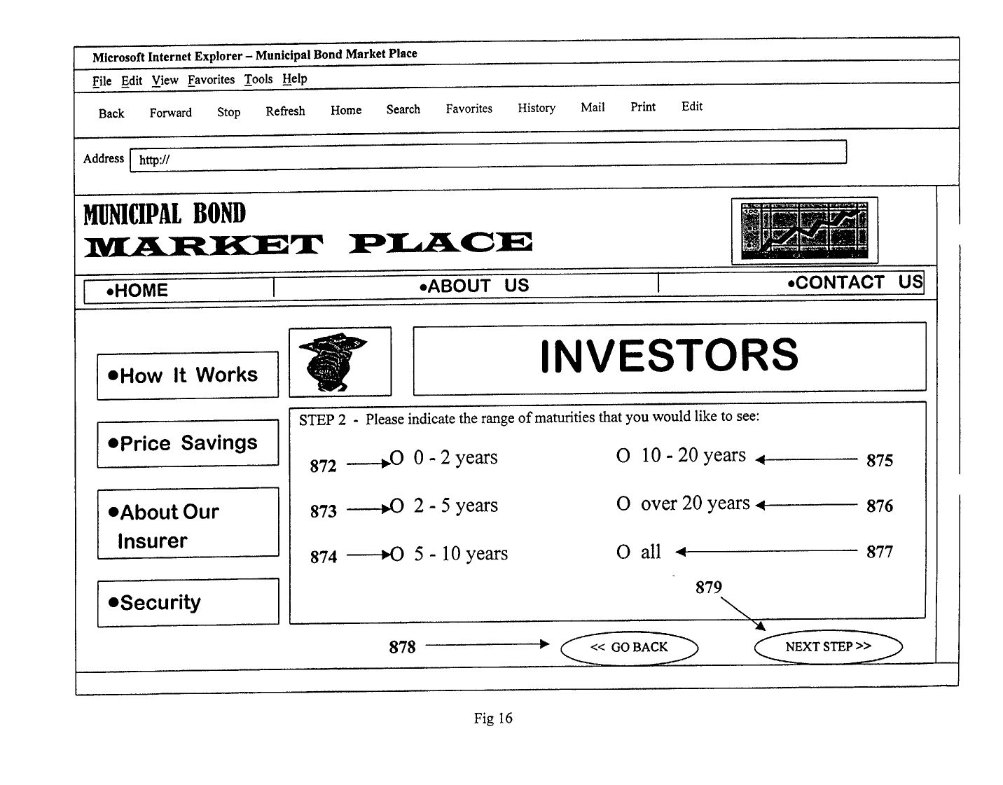

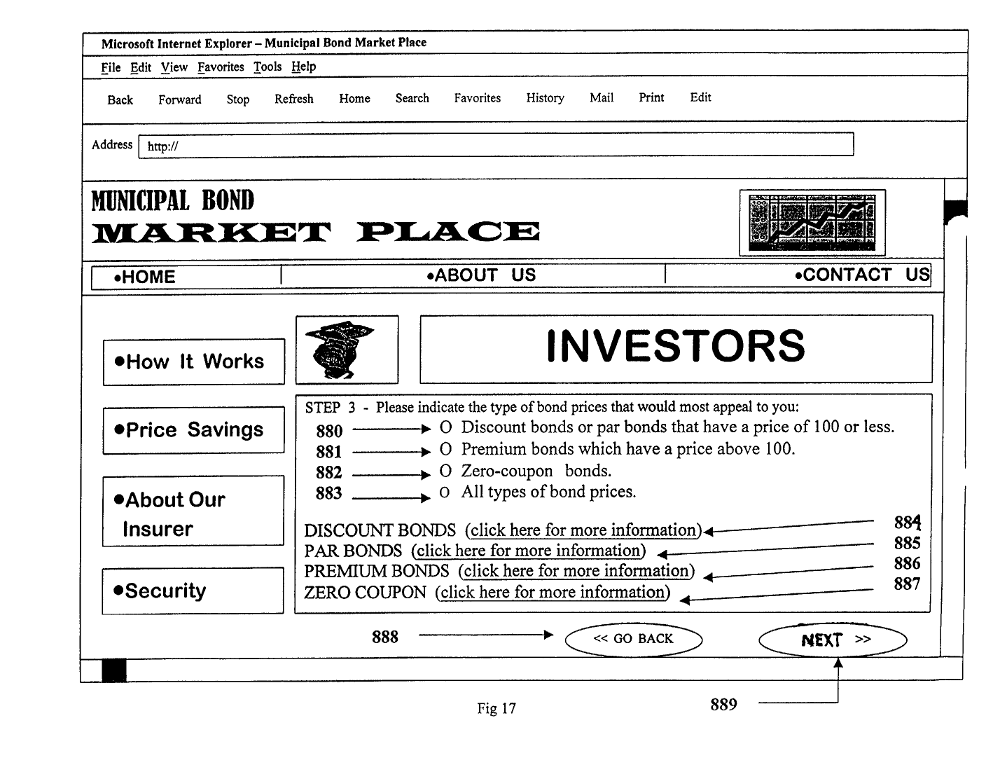

The user may click or select one or more STATES 870. If the user clicks or selects NEXT STEP 871, the system and/or method in accordance with embodiments of the present invention may communicate to the user a bond length web page such as but not limited to the one embodied in the exemplary screenshot shown in FIG. 16. Referring to FIG. 16, the user, such as but not limited to an investor, may select from various ranges of bond maturity lengths, such as, but not limited to, ZERO TO TWO YEARS 872, TWO TO FIVE YEARS 873, FIVE TO TEN YEARS 874, TEN TO TWENTY YEARS 875, OVER TWENTY YEARS 876, and/or ALL 877. If the investor clicks or selects NEXT STEP 879, the system and/or method in accordance with embodiments of the present invention may communicate to the user a bond type web page such as but not limited to the one embodied in the exemplary screenshot shown in FIG. 17. Referring again to FIG. 16, the investor may select GO BACK 878 to return to a previously viewed web page.

Referring to FIG. 17, the system and/or method in accordance with embodiments of the present invention may present to the user, for example, a choice of types of bond prices and/or types, such as but not limited to DISCOUNT BONDS OR PAR BONDS PRICED BELOW 100 880, PREMIUM BONDS PRICED ABOVE 100 881, ZERO-COUPON BONDS 882, and/or ALL TYPES OF BOND PRICES 883.

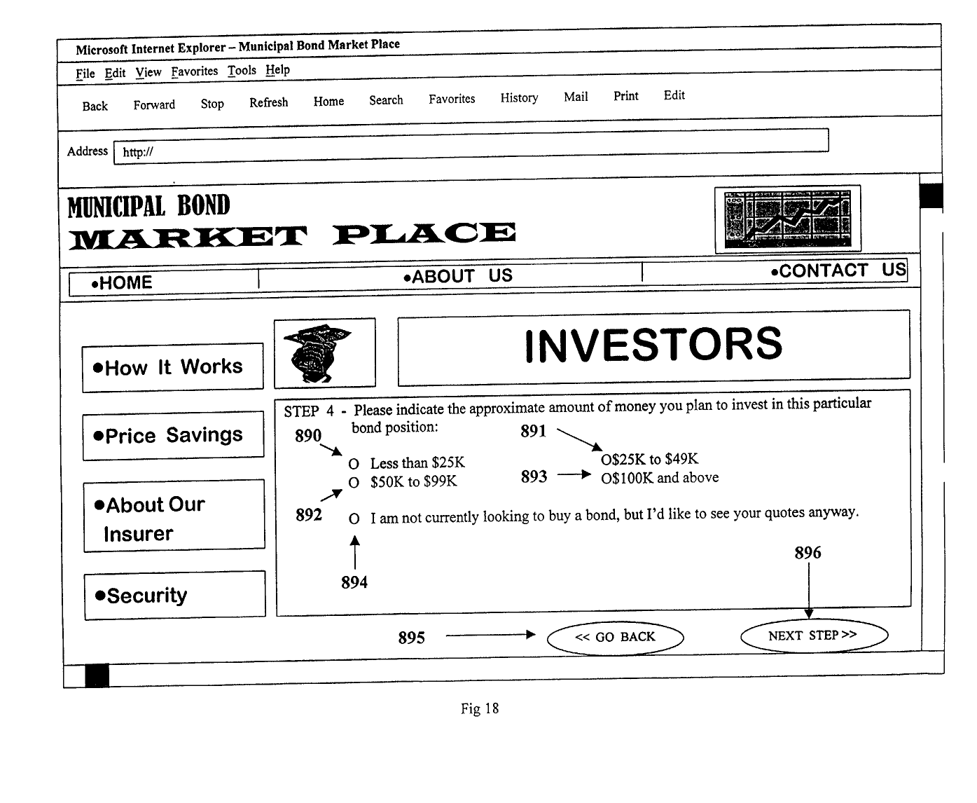

Referring again to FIG. 17 the user or investor may click or select links associated with different types of bonds to receive more information describing those bonds. These types may include, without limitation, DISCOUNT BONDS 884, PAR BONDS 885, PREMIUM BONDS 886, ZERO-COUPON BONDS 887, and/or any other types of bonds. After selecting one or more types or categories of bonds, the user may click or select NEXT 889. If the user clicks or selects NEXT 889, the system and/or method in accordance with embodiments of the present invention may communicate to the user an investment amount web page such as but not limited to the one embodied in the exemplary screenshot shown in FIG. 18. Referring again to FIG. 17, if user clicks or selects GO BACK 888, the user may return to a previously viewed web page.

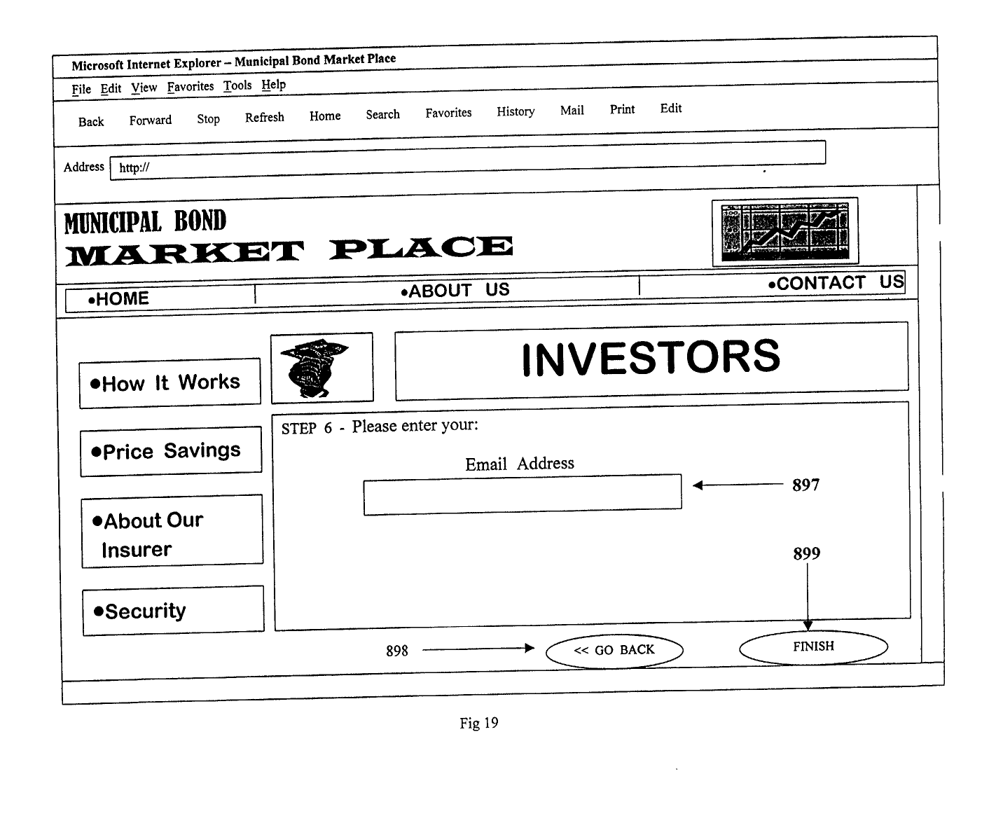

Referring again to FIG. 18, the user or investor may select one or more options among, for example, choices of ranges of amounts in which the user plans to invest. These amounts may include, without limitation, LESS THAN $25,000 890, $25,000 TO $49,000 891, $50,000 TO $99,000 892, and/or $100,000 AND ABOVE 893. The user or investor click or select QUOTES 894, wherein the system and/or method in accordance with embodiments of the present invention may, for example communicate to the user some or all possible amounts in which investments may be made. After selecting one or more ranges, the user or investor may click or select NEXT STEP 896. If the user clicks or selects NEXT STEP 896, the system and/or method in accordance with embodiments of the present invention may communicate to the user an e-mail web page such as but not limited to the one embodied in the exemplary screenshot shown in FIG. 19. Referring again to FIG. 18, the user may also click or select GO BACK 895 to return to a previously viewed web page.

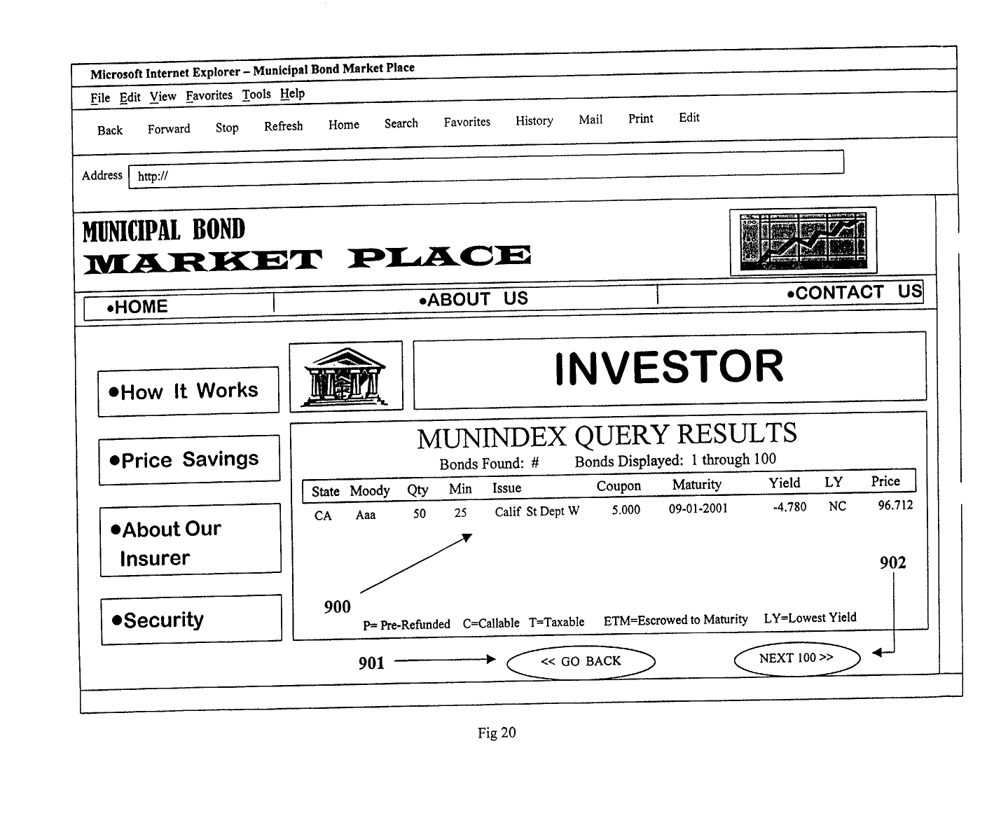

Referring again to FIG. 19, the investor may enter a contact E-MAIL ADDRESS 897, where, for example, the investor may receive price quotes on information relating to bond prices and yields, for example, from the system and/or method in accordance with embodiments of the present invention. Referring again to FIG. 19, the investor may click or select FINISH 899 to view a munindex pricing engine query result web page such as but not limited to the one embodied in the exemplary screenshot shown in FIG. 20. Referring again to FIG. 19, the investor may click or select GO BACK 898 to return to a previously viewed web page.

Referring again to FIG. 20 the system and/or method in accordance with embodiments of the present invention may communicate to the user QUERY RESULTS 900 information relating to, for example, a number of bonds found, a number of bonds displayed, an associated state, a credit rating, a bond quantity, a type of issue, a coupon rate, a maturity date, a current yield, a lowest yield, a price, and other information. The investor may also view more bonds within the query by selecting or clicking NEXT 100 902.

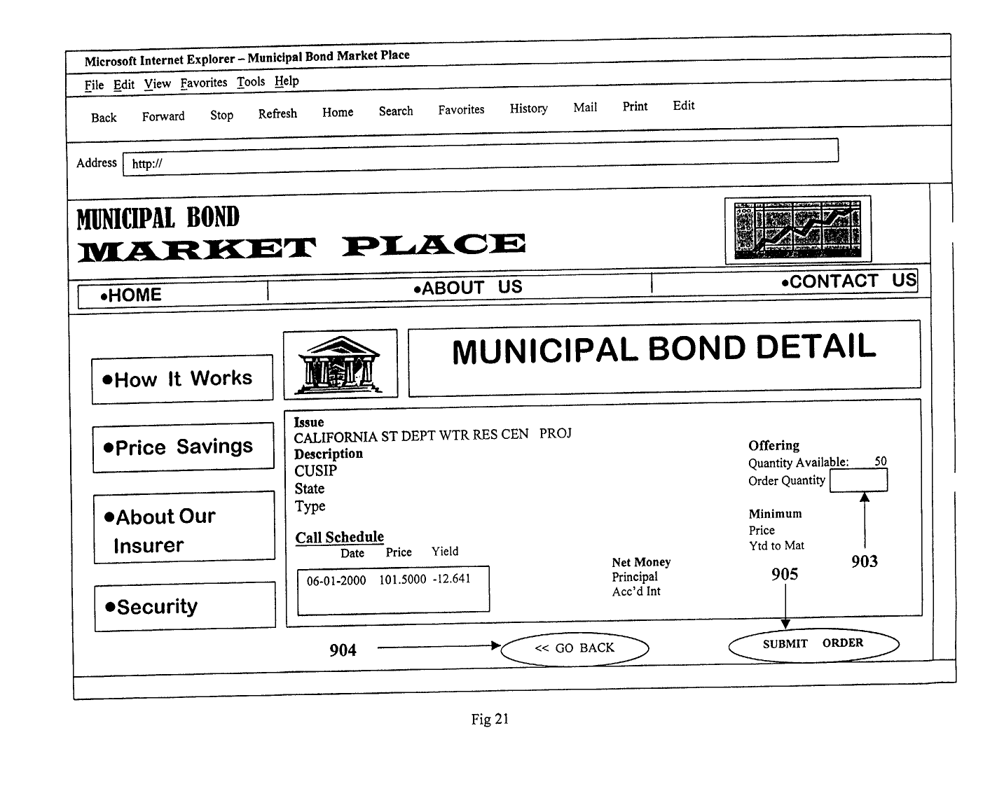

Referring again to FIG. 20, the user may click or select any one or more bonds shown in QUERY RESULTS 900. If a user clicks or selects a displayed bond, the system and/or method in accordance with embodiments of the present invention may communicate to the user more information about that bond, for example as shown in a municipal bond detail web page such as but not limited to the one embodied in the exemplary screenshot shown in FIG. 21. Referring again to FIG. 20, the investor may click or select GO BACK 901 to return to a previously viewed web page.

Referring again to FIG. 21, the user, such as but not limited to an investor, may enter an ORDER QUANTITY 903 for the associated offering, such as but not limited to a municipal bond. The investor may then click or select SUBMIT ORDER 905 to transmit the bond order, including the associated ORDER QUANTITY 903 to the system and/or method in accordance with embodiments of the present invention. Referring again to FIG. 21, the investor may click or select GO BACK 904 to return to a previously viewed web page.

The method and system of the present invention allows an investor to select types and ranges of bond values to purchase, and then the system and/or method in accordance with embodiments of the present invention may use a standard query mechanism to match results with those selected ranges and types.

The system and/or method in accordance with embodiments of the present invention eliminates many of the costs in a bond issuance, such as but not limited to costs of counsel and other entities. The munindex pricing engine of the system and/or method in accordance with embodiments of the present invention may be associated with a compilation of historic information. The munindex pricing engine processes all prior issues in a given category, analyzes the interest rates achieved based on objective market criteria, such as the municipal bond index at time point of issuance. In an embodiment of the invention, the munindex pricing engine of the system and/or method in accordance with embodiments of the present invention also analyzes regional variances to compute a bond price or interest rate.

In an embodiment of the invention, the munindex pricing engine may reflect regional variances. An example of a regional variance is that California has a state income tax that is roughly 8%, and it may have federal income tax as well. With California municipal debt, the interest that a purchaser receives is exempt from both state income tax and federal income tax. In an embodiment of the invention, for a bond issued by the state of Nevada to a purchaser living in California, the interest may not be exempt from California state income taxes, so the state of California or its entities may pay a lower interest rate on the same quality obligation or credit obligation than a similar entity in Nevada. In another example, the cities of San Francisco and Las Vegas may have the same credit rating, but the city of San Francisco would obtain for its general obligation bond would be higher by a small amount than the city of Las Vegas because there are other variances based on the secondary market value of the bond or paper.

In further exemplary embodiment of the invention, a California issue may have more buyers than a comparable Nevada issue. Therefore, demand for the paper the California paper leads to a stronger secondary market in California, or a higher sell price in the stronger California secondary market. A bond or piece of paper from Oregon may have a more limited secondary market demand as well. Also, certain states are strong bond states, such as, historically, Washington. As a result, Washington bond or paper may draw a higher price than a California paper with the same credit quality even though Washington may have a lower tax income tax.

The munindex pricing engine of the system and/or method in accordance with embodiments of the present invention analyzes historical data of a state to calculate a market bond price for a given issue. The munindex pricing engine of the system and/or method in accordance with embodiments of the present invention also incorporates each day's trading variations. For example, on a given day, California bonds may be priced at 102.45% of the municipal index, and Illinois bonds may be priced at 99.3% of the municipal index. These two factors, such as historical data pricing and trading day variation, may be each be weighted by the munindex pricing engine. Historical data may become more important for issuers in states with a very low secondary market and a very low trading volume because there may be little trading day data. In an exemplary embodiment of the invention, for the state of Indiana, an average over the last four months of trading may be used. In an exemplary embodiment of the invention, for the city of New York, the trading day's data is used due to the huge volume.

The system and/or method in accordance with embodiments of the present invention presents to the purchaser the munindex pricing engine, which does not use a negotiated market price as traditionally done, but rather calculates a rate that is determined based on objective historical and trading day factors. The system and/or method in accordance with embodiments of the present invention evaluates the underlying factors to present to the purchaser a preferred manner of managing the purchaser's portfolio. Historical analysis associated with the system and/or method in accordance with embodiments of the present invention is made available to both purchaser and issuer.

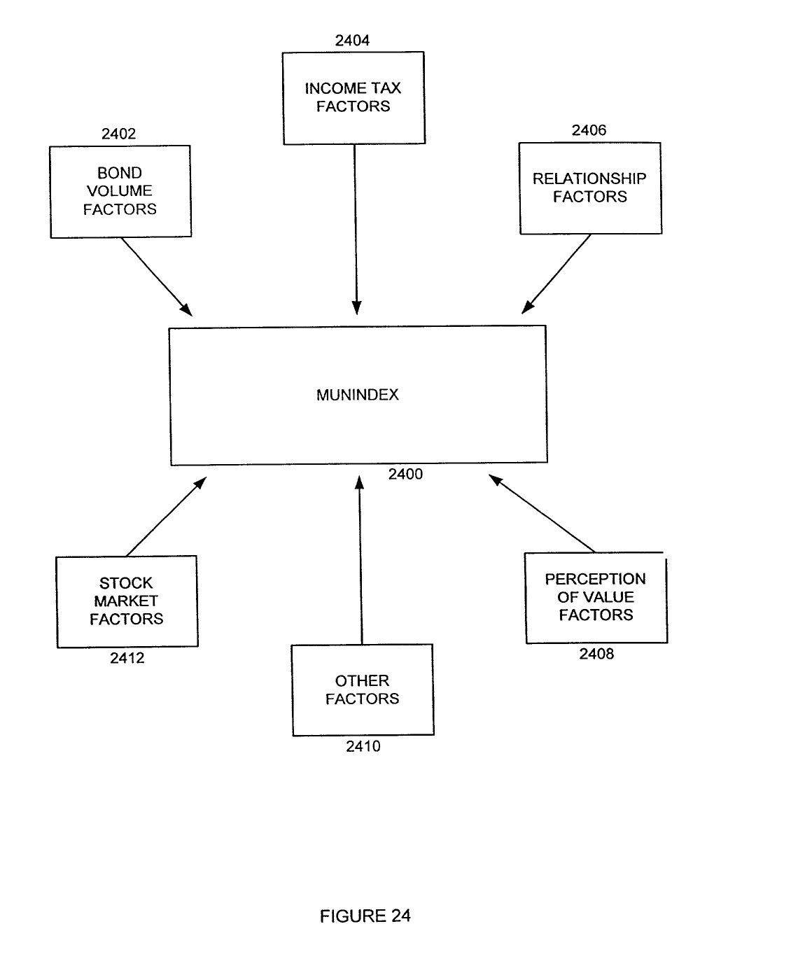

Referring to FIG. 24, the munindex pricing engine 2400 of the system and/or method in accordance with embodiments of the present invention performs analysis to determine an fair bond price based on factors such as but not limited bond volume factors 2402, income tax factors 2404, and relationship factors 2406. The munindex is computerized or automated. Bond volume factors 2402 may be the volume of bonds in that particular category traded in the secondary market. Income tax factors 2404 may be state income tax factors. Relationship factors 2406 may be associated with pricing of a particular credit to national indexes such as a market association index or a bond buyer index.

Munindex pricing engine 2400 of the system and/or method in accordance with embodiments of the present invention also performs analysis to determine an fair bond price based on perception of value factors 2408 in a given region. In an exemplary embodiment of the invention, perception of value factors 2408 may be involved in bond issuances related to school financings in the state of Michigan due to a higher traditional price in that state due to the perception of value of education by residents of that state. Munindex pricing engine 2400 considers stock market factors 2412. In an exemplary embodiment of the invention, stock market factors 2412 may occur when the stock market is devalued, at which time bond prices may be increased. Stock market factors may be considered a minor element for munindex pricing engine 2400. Other factors 2410 may include, for example, regional demand variations for municipals.

The system and/or method in accordance with embodiments of the present invention may create value by demystifying some of the fear factors involved in municipal bonds. The system and/or method in accordance with embodiments of the present invention may help transform municipal bonds into a stock market model in terms of liquidity and price certainty. The system and/or method in accordance with embodiments of the present invention may create a marketplace where buyers and sellers have in effect a transparent price where the price is being set based on objective market factors and historical data.

Data associated with the system and/or method in accordance with embodiments of the present invention may be shown in a visual presentation format, such as through one or more links associated with a web site associated with the system and/or method in accordance with embodiments of the present invention.

The system and/or method in accordance with embodiments of the present invention allows an offer and a sale of municipal bonds without having either bond counsel or traditional underwriters.

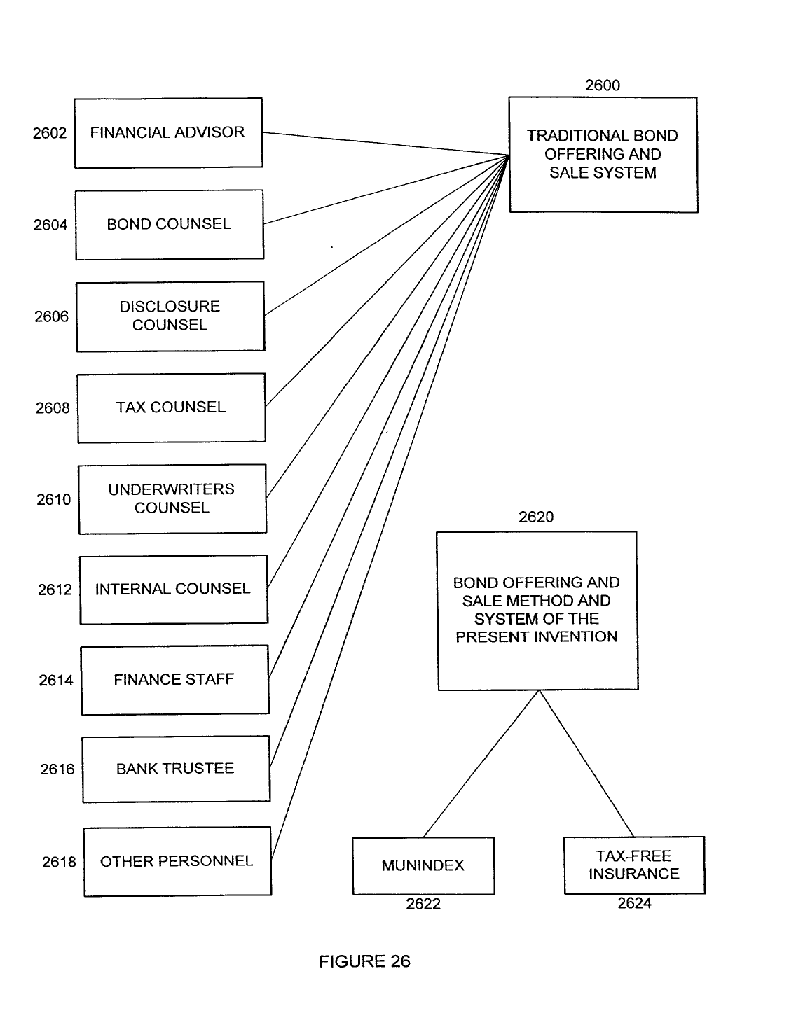

The system and/or method in accordance with embodiments of the present invention may eliminate one or more of the entities as shown in FIG. 26. Traditional bond offering and sale system 2600 requires financial advisor 2602, bond counsel 2604, disclosure counsel 2606, tax counsel 2608, underwriters counsel 2610, internal counsel 2612, finance staff 2614, bank trustee 2616, and other personnel 2618. Bond offering and sale method and system of the present invention 2620 may eliminate all of those entities, including financial advisor 2602, bond counsel 2604, disclosure counsel 2606, tax counsel 2608, underwriters counsel 2610, internal counsel 2612, finance staff 2614, bank trustee 2616, and other personnel 2618. Bond offering and sale method and system of the present invention 2620 may eliminate one or more of financial advisor 2602, bond counsel 2604, disclosure counsel 2606, tax counsel 2608, underwriters counsel 2610, internal counsel 2612, finance staff 2614, bank trustee 2616, and other personnel 2618.

Financial advisor 2602 of the traditional bond offering and sale system 2600 in the prior art advises the issuer regarding placing a request for proposals or putting bonds out for bid, prepares an official statement, and analyzes different structures. Bond counsel 2604 of the traditional bond offering and sale system 2600 in the prior art prepares documents such as a bond indenture and an actual bond purchase agreement with the underwriters. Disclosure counsel 2606 of the traditional bond offering and sale system 2600 in the prior art prepares a preliminary official statement, such as an S1 or disclosure document. Special tax counsel 2608 of the traditional bond offering and sale system 2600 in the prior art writes a tax opinion that says the bonds are free from income tax, as well as federal income tax. Underwriters counsel 2610 of the traditional bond offering and sale system 2600 in the prior art performs a blue sky survey that shows whether a bond can be sold or what the sale requirements are for a particular state. Underwriters counsel 2610 of the traditional bond offering and sale system 2600 in the prior art writes an opinion saying that the underwriters have not violated rules in connection with disclosures and prepare an agreement among the underwriters in order to review the bond purchase agreement, which is prepared by bond counsel 2604 of the traditional bond offering and sale system 2600 in the prior art. Bond counsel 2604 represents an issuer or municipality. The issuer or municipality has internal counsel 2612 of the traditional bond offering and sale system 2600 in the prior art. Internal counsel 2612 writes an opinion saying that parties have complied with proper resolutions and formalities. Internal counsel 2612 gives the opinion to bond counsel 2604, who then writes the opinion again. Finance staff 2614 of the traditional bond offering and sale system 2600 in the prior art is an internal finance staff of the issuer or municipality who has worked with various entities to prepare the necessary documents.

Bank trustee 2616 of the traditional bond offering and sale system 2600 in the prior art takes payments from the issuer or municipality and distributes them to investors. The system and/or method in accordance with embodiments of the present invention wires payments directly to an investor bank or brokerage account. The investor may choose where the money is to be wired, such as to a bank or a brokerage account. In the prior art, many bond payments and coupons escheat to the state because either payment information is lost, or the investor has died. Also, in the prior art, a bondholder can not readily communicate with the issuer or payer. Investors associated with the system and/or method in accordance with embodiments of the present invention may have interest in a bond purchase sent, for example, to a bank account, to a stock purchase account, to a trust fund, or to a bank in Europe. The bondholder associated with the system and/or method in accordance with embodiments of the present invention may communicate with the system and/or method in accordance with embodiments of the present invention through an on-line message to direct the payment procedure and destination.

In the prior art, bond payment destination changes require writing of a letter and signing of materials to prove recipient identification. The system and/or method in accordance with embodiments of the present invention has an associated bank card with a user identification and password, so that a trustee or other payee destination may readily be changed by an investor. In the prior art, such as in the traditional bond offering and sale system 2600, if an investor dies, forms must be sent to a trustee for a series of signatures. In the prior art, such as in the traditional bond offering and sale system 2600, when and if an investor changes the investor's last name, at least three weeks are typically required to send the forms to change a name and redirect interest payments. The traditional bond offering and sale system 2600 also requires a notary associated with document delivery, which is no guarantee of safety. The system and/or method in accordance with embodiments of the present invention allows on-line instantaneous payment redirection and changing of related information, such as names and payee destinations in response to desires of a bond owner or investor.

Bond offering, sale, and management method and system of the present invention 2620 may be associated with munindex pricing engine 2622 and tax-free insurance 2624.

In an embodiment of the invention, the bond offering, sale, and management method and system 2620 accomplishes the elimination of members 2602, 2604, 2606, 2608, 2610, 2612, 2614, 2616, and 2618 of traditional bond offering and sale system 2600 by instituting or using standard documentation for given types of issues. In the prior art bond marketplace, such as one associated with traditional bond offering and sale system 2600, standardized documentation has developed. This standardized documentation may be promulgated by different law firms. Such standardized documentation may be loan documents, for example relating to a trust indenture. A trust indenture, for example, is a loan agreement where the obligor is the municipality, and where the lender is the bond holder who is paid an interest rate. In the prior art, bond documents may be well established in the law, with little creative case law, with no variation between the 50 states.

In the prior art, tax counsel 2608 may issue a tax opinion that supposedly guarantees that the municipalities get tax exempt interest. Tax counsel 2608 in the prior art may not have professional liability insurance and is not truly a guarantee of what an investor may actually receive. In an embodiment of the invention, the bond offering, sale, and management method and system of the present invention 2620 uses tax-free-insurance 2624, which may be a guarantee that an investor obtains tax exempt interest from a bond purchase. In an embodiment of the invention, tax-free insurance 2624 may be obtained from an insurance company. In an embodiment of the invention, unlike in the prior art, there may be no tax counsel 2608 or tax opinion. In an embodiment of the invention, unlike in the prior art, tax-free insurance may be associated with each bond sale or purchase by providing an associated investor with an absolute guarantee by a AAA rated multibillion dollar insurance company.

FIG. 27 shows an exemplary flowchart of tax-free insurance 2624 in detail. After a sale or purchase of bonds associated with the system and/or method in accordance with embodiments of the present invention, an eventual determination may be made by, for example a government entity, as to whether the bonds are tax-free 2700. If the bonds are tax-free 2702, tax-free insurance may not be invoked. If the bonds are not tax free 2704, tax-free insurance may be invoked by having bonds repurchased or a supplemental payment made 2706. In step 2706, bonds may be bought back by the associated insurance company or another entity. Alternatively, in step 2706, a supplemental payment, for example, may be made from the insurance company or another entity to the investor, trustee, or another entity. Other measures may be taken when tax-free insurance is invoked, such as partial payments, transfer of other consideration, or other measures. The supplemental payment may equal to what the bond would have been worth if the bond interest had been tax-free.

The system and/or method in accordance with embodiments of the present invention may require an issuer seeking money through issuance of municipal bonds to perform credit check steps. The issuer may be required to communicate standard identification, background, and credit information to the system and/or method in accordance with embodiments of the present invention. A national credit rating agency may perform a report and evaluation regarding the credit of the issuer. Each bond issue having associated payments from one or more municipalities may be guaranteed by a major credit enhancement or credit guarantee agency, such as but not limited to MBIA. Bonds sold in accordance with the system and/or method in accordance with embodiments of the present invention are AAA rated bonds, which eliminates concern about sufficient and proper disclosures because the credit agency may guarantee payment.

The system and/or method in accordance with embodiments of the present invention creates an easy, efficient, quick, and secure way for one or more municipalities to borrow money from one or more investors, such as individual investors and/or institutional investors, where interest associated with the borrowed money may be guaranteed to be at tax exempt rates.

A munindex pricing engine of the system and/or method in accordance with embodiments of the present invention may determine, for example at the end of each trading day, yields for bonds, based on market indices, current trades, special characteristics of the bonds to be sold, and other factors, therefore eliminating the need for financial advisors and traditional underwriters. In an embodiment of the invention, a web site associated with the system and/or method in accordance with embodiments of the present invention may provide, for example, information for future and past securities offerings, such as but not limited to bond offerings, historical data, related news articles, free portfolio evaluations, and other services.

In an embodiment of the invention, the system and/or method in accordance with embodiments of the present invention offers and sells securities, such as but not limited to municipal bonds, without traditional securities sale requirements. In an embodiment of the invention, the system and/or method in accordance with embodiments of the present invention allows for a paperless system of disclosure, use of standard documentation on-line, continuing disclosure on-line, and elimination of the need for a financial printer.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

What is claimed is:

1. A method for managing a securities transaction in a system having one or more servers, one or more clients, and one or more databases, comprising:
receiving over a network an application for money from an entity, wherein the application for money indicates and is associated with the securities transaction; and
determining to which of a plurality of categories the securities transaction belongs and, based on the determination, presenting at least one standard document associated with that category.

2. The method of claim 1, and further comprising:
before presenting the at least one standard document, modifying the at least one standard document based on the application for money.

3. The method of claim 1, wherein the entity is one or more members selected from the group consisting of an issuer, an issuer financial staff, and a financial advisor.

4. The method of claim 1, wherein the securities transaction is a municipal bond sale.

5. The method of claim 1, wherein the network is the Internet.

6. The method of claim 1, wherein the one or more standard documents includes one or more members selected from the group consisting of an official statement, a bond indenture, a county resolution, a municipal board resolution, an actual form of bond, a legal opinion, and a certificate of the clerk.

7. The method of claim 1, further comprising communicating the at least one standard documents to the client.

8. The method of claim 1, further comprising communicating for display to the client a representation of one or more of the one or more standard documents on a web page associated with the system.

9. The method of claim 1, further comprising communicating for display to the client a link to a representation of one or more of the one or more standard documents on a web page associated with the system.

10. The method of claim 1, further comprising obtaining, receiving, or communicating a tax-free guarantee associated with the securities transaction.

11. The method of claim 1, further comprising receiving a request to sample one or more pricing dates associated with the securities transaction.

12. A method for conducting a bond sale transaction, comprising:
receiving an application to issue for sale a set of one or more bonds; and
issuing for sale the set of bonds, including preparing for the bond sale without communicating with a counsel.

13. The method of claim 12, wherein the counsel is a bond counsel.

14. The method of claim 12, wherein the bonds are municipal bonds.

15. The method of claim 12, wherein the step of preparing for the bond sale includes preparing a tax opinion.

16. A method for conducting a bond sale transaction, comprising:
receiving an application to issue for sale a set of one or more bonds; and
issuing for sale the set of bonds, wherein the method includes preparing for the bond sale and selling the set of bonds without communicating with one or more of the members selected from the group consisting of a financial advisor, a bond counsel, a disclosure counsel, a tax counsel, an underwriters counsel, an internal counsel, a finance staff, and a bank trustee.

17. A method for managing a bond sale in a system having a network, one or more servers, one or more clients, and one or more databases, comprising:
receiving an indication of interest in a bond sale; and
processing the indication of interest by a pricing engine to determine a price for a bond associated with the bond sale.

18. The method of claim 17, wherein the pricing engine is automated or computerized.

19. The method of claim 17, wherein the bond is a municipal bond.

20. The method of claim 17, wherein the pricing engine determines the price based on at least one member selected from the group consisting of a bond volume factor, an income tax factor, a relationship factor, a perception of value factor, and a stock market factor.

21. A method for managing a bond transaction in a system having one or more servers, one or more clients, and one or more databases, comprising:
communicating over a network for display to at least one of the one or more clients at least one member selected from the group consisting of one or more initial bond offering documents, data related to historical bond pricing, data related to pricing of similar past bond offerings, data related to one or more news articles associated with the bond transaction, one or more links associated with a newspaper having one or more articles related to the bond transaction, and one or more links to a news article associated with the bond transaction.

22. The method of claim 21, wherein the bond transaction is a bond offering or sale.

23. A method for managing a sale of securities in a system having one or more servers, one or more clients, and one or more databases, comprising:
accepting one or more orders for one or more of the securities from one or more individual investors before accepting one or more orders for one or more of the securities from one or more institutional investors.

24. The method of claim 23, wherein the accepting of the one or more orders for the one or more securities from the one or more individual investors occurs at least one day before the accepting of the one or more orders for the one or more securities from the one or more institutional investors.

25. The method of claim 23, wherein the securities are bonds.

26. A computer program product for use in managing a securities transaction in a system including one or more servers, one or more clients, and one or more databases, said computer program product comprising a computer readable medium including:
computer readable program code embodied in said medium configured to cause the computer to receive over a network an application for money from an entity, wherein the application for money is associated with the securities transaction;
computer readable program code for causing a computer to effect reviewing the application for money; and
computer readable program code for causing said computer to determine to which of a plurality of categories the securities transaction belongs and, based on the determination, to present at least one standard document associated with that category.

27. An article of manufacture comprising:
a computer readable medium including computer readable program code embodied therein for causing managing a securities transaction in a system including one or more servers, one or more clients, and one or more databases, the computer readable program code in said article of manufacture comprising:
computer readable program code for causing a computer to effect receiving over a network an application for money from an entity, wherein the application for money is associated with the securities transaction;
computer readable program code for causing the computer to effect reviewing the application for money; and
computer readable program code for causing said computer to determine to which of a plurality of categories the securities transaction belongs and, based on the determination, to present at least one standard document associated with that category.

28. A computer program product for use in conducting a bond sale transaction, said computer program product comprising:
a computer readable medium including computer readable program code embodied in said medium for causing receiving an application to issue for sale a set of one or more bonds; and
computer readable program code for causing a computer to effect issuing for sale the set of bonds, wherein the method includes preparing for the bond sale without communicating with a counsel.

29. An article of manufacture comprising:
a computer readable medium including computer readable program code embodied therein for causing conducting a bond sale transaction, the computer readable program code in said article of manufacture comprising:
computer readable program code for causing a computer to effect receiving an application to issue for sale a set of one or more bonds; and
computer readable program code for causing the computer to effect issuing for sale the set of bonds, wherein the method includes preparing for the bond sale without communicating with a counsel.

30. A computer program product for use in conducting a bond sale transaction, said computer program product comprising:
a computer readable medium including computer readable program code embodied in said medium for causing receiving an application to issue for sale a set of one or more bonds; and
computer readable program code for causing a computer to effect issuing for sale the set of bonds, wherein the method includes preparing for the bond sale without communicating with one or more of the members selected from the group consisting of a financial advisor, a bond counsel, a disclosure counsel, a tax counsel, an underwriters counsel, an internal counsel, a finance staff, and a bank trustee.

31. An article of manufacture comprising:
a computer readable medium including computer readable program code embodied therein for causing conducting a bond sale transaction, the computer readable program code in said article of manufacture comprising:
computer readable program code for causing a computer to effect receiving an application to issue for sale a set of one or more bonds; and
computer readable program code for causing the computer to effect issuing for sale the set of bonds, wherein the method includes preparing for the bond sale without communicating with one or more of the members selected from the group consisting of a financial advisor, a bond counsel, a disclosure counsel, a tax counsel, an underwriters counsel, an internal counsel, a finance staff, and bank trustee.

32. A computer program product for use in managing a bond transaction in a system having one or more servers, one or more clients, and one or more databases, said computer program product comprising:
a computer readable medium including computer readable program code embodied in said medium for causing communicating over a network for display to at least one of the one or more clients at least one member selected from the group consisting of one or more initial bond offering documents, data related to historical bond pricing, data related to pricing of similar past bond offerings, data related to one or more news articles associated with the bond transaction, one or more links associated with a newspaper having one or more articles related to the bond transaction, and one or more links to a news article associated with the bond transaction.

33. An article of manufacture comprising:
a computer readable medium including computer readable program code embodied therein for causing managing a bond transaction in a system having one or more servers, one or more clients, and one or more databases, the computer readable program code in said article of manufacture comprising:
computer readable program code for causing a computer to effect communicating over a network for display to at least one of the one or more clients at least one member selected from the group consisting of one or more initial bond offering documents, data related to historical bond pricing, data related to pricing of similar past bond offerings, data related to one or more news articles associated with the bond transaction, one or more links associated with a newspaper having one or more articles related to the bond transaction, and one or more links to a news article associated with the bond transaction.

34. A computer program product for use in managing a sale of securities in a system having one or more servers, one or more clients, and one or more databases, said computer program product comprising:
a computer readable medium including computer readable program code embodied in said medium for causing accepting one or more orders for one or more of the securities from one or more individual investors before accepting one or more orders for one or more of the securities from one or more institutional investors.

35. An article of manufacture comprising:
a computer readable medium including computer readable program code embodied therein for causing managing a sale of securities in a system having one or more servers, one or more clients, and one or more databases, the computer readable program code in said article of manufacture comprising:
computer readable program code for causing a computer to effect accepting one or more orders for one or more of the securities from one or more individual investors before accepting one or more orders for one or more of the securities from one or more institutional investors.

36. The method of claim 1, further comprising creating or presenting an online secondary market for sale of the securities.

37. The method of claim 23, wherein the accepting of the one or more orders for the one or more securities from the one or more individual investors occurs at least two hours before the accepting of the one or more orders for the one or more securities from the one or more institutional investors.
